(19) United States
(12) Patent Application Publication
(10) Pub. No.: US 2012/0247425 A1
(43) Pub. Date: Oct. 4, 2012

(54) METHOD AND APPARATUS FOR A HIGH FLOW CYLINDER HEAD FOR INTERNAL COMBUSTION ENGINES

(76) Inventor: Daniel Richard, Keyport, NJ (US)

(21) Appl. No.: 13/431,846

(22) Filed: Mar. 27, 2012

Related U.S. Application Data
(60) Provisional application No. 61/468,378, filed on Mar. 28, 2011.

(51) Int. Cl. F02B 57/04; B23P 11/00

(52) U.S. Cl. 123/43 R; 29/888.06

(57) ABSTRACT

A solid portion having a first opening, a second opening, and a third opening, leading to a chamber. The first, second, and third openings may be located at a top, bottom, and periphery of the solid portion, wherein the periphery is substantially perpendicular to the top and the bottom of the solid portion. A plurality of gear teeth may be located nearer the top of the solid portion than the bottom of the solid portion. One or more magnets may be located nearer the top of the solid portion than the bottom of the solid portion. A first plurality of ball bearings may be located nearer the top of the solid portion than the bottom of the solid portion. The solid portion may be mounted in a cylindrical cavity of an internal combustion engine so that the solid portion can rotate within the cylindrical cavity.

### CROSS REFERENCE TO RELATED APPLICATION(S)

The present application claims the priority of U.S. provisional patent application Ser. No. 61/468,378, filed on Mar. 28, 2011, applicant Daniel Richard, titled “High Flow Cylinder Head with Variable Valve Timing and Ability to Disengage Pistons under Computer Control”.

### FIELD OF THE INVENTION

This invention relates to improved methods and apparatus concerning cylinder heads, intake and exhaust for internal combustion engines.

### BACKGROUND OF THE INVENTION

Traditional cylinder heads of engines, such as vehicle engines, contain valves opening and closing to allow a fuel air mixture into a piston cylinder and allow exhaust gases out at appropriate times in a cycle. These valves are limited in size by the geometry of existing engines, and are a bottle neck in the flow of air into and out of the piston cylinder.

### SUMMARY OF THE INVENTION

One or more embodiments of the present invention allow a cross sectional area of an open intake and an exhaust valve to be substantially larger—on the order of double the cross sectional area of conventional valves, resulting in higher performance and better fuel economy for an internal combustion engine, such as vehicle engine, wherein the vehicle can be a car, a truck, a motorcycle, or a bus, etc. One or more embodiments of the present invention can be applied to any internal combustion engine.

One or more embodiments of the present invention achieve substantial cost savings and higher reliability by eliminating the need for a cam shaft, push rods, lifters, rockers, valves, valve springs, timing Chain, timing Gears, and other components in an engine, such as an automobile engine.

One or more embodiments of the present invention provide continuously variable valve timing, which is achieved through computer control without mechanical complexity.

In one or more embodiments of the present invention piston cylinders in an engine, such as an automobile engine, are disengaged and re-engaged in a seamless manner under computer control without mechanical complexity, allowing increased fuel efficiency.

In one or more embodiments of the present invention, a non-interference engine, for an engine, such as an automobile engine, is provided without sacrificing compression ratio.

In at least one embodiment of the present invention a solid portion is provided. The solid portion may have a first opening, a second opening, a third opening, and a chamber. The first opening, the second opening, and the third opening may lead to the chamber. The first opening may be located a top of the solid portion; the second opening may be located at a bottom of the solid portion, opposite the top of the solid portion. The third opening may be located at a periphery of the solid portion, wherein the periphery is substantially perpendicular to the top and the bottom of the solid portion. The third opening may be called a puck port.

A plurality of gear teeth may be located nearer the top of the solid portion than the bottom of the solid portion. One or more magnets may be located nearer the top of the solid portion than the bottom of the solid portion. A first plurality of ball bearings may be located nearer the top of the solid portion than the bottom of the solid portion. The solid portion may have a substantially cylindrical outer shape.

An apparatus may be provided including the solid portion and further including an internal combustion engine cylinder head having a cylindrical cavity. The solid portion may be mounted in the cylindrical cavity of the internal combustion engine so that the solid portion can rotate within the cylindrical cavity. The internal combustion engine cylinder head may include a first electromagnet. The solid portion may rotate at least in part in response to the first electromagnet interacting with the first magnet.

The apparatus may further include a computer. The computer may be programmed to control the first electromagnet and thereby control, at least in part, the rotation of the solid portion. The internal combustion engine cylinder head may have an exhaust port and an intake port. The solid portion may be configured to be rotated to align the third opening (or puck port) with the exhaust port but not the intake port, in a first orientation state. The solid portion may be configured to be rotated to align the third opening (or puck port) with the intake port but not the exhaust port, in a second orientation state.

One or more embodiments of the present application may also include a method including inserting a solid portion into a cylindrical head cavity of an internal combustion cylinder head so that the solid portion can rotate. The solid portion may be as described. The method may further include rotating the solid portion to align the third opening with the exhaust port but not the intake port, in a first orientation state; and rotating the solid portion to align the third opening with the intake port but not the exhaust port, in a second orientation state.

### BRIEF DESCRIPTION OF THE DRAWINGS

FIG. 1A is a top view of an apparatus, rotating valve or puck in accordance with an embodiment of the present invention;

FIG. 1B shows a cross section of part of the puck of FIG. 1A cut along a horizontal center line.

FIG. 1C shows a cross section of part of the puck of FIG. 1A cut along a vertical center line;

FIG. 1D shows a bottom front perspective view of an apparatus for forming the puck of FIG. 1A;

FIG. 1E shows a top rear perspective view of the apparatus of FIG. 1D, for forming the puck of FIG. 1A;

FIG. 1F shows a bottom front perspective view of a first modified apparatus for forming the puck of FIG. 1A;

FIG. 1G shows a top rear perspective view of the first modified apparatus of FIG. 1F;

FIG. 1H shows a bottom front perspective view of a second modified apparatus for forming the puck of FIG. 1A;

FIG. 1I shows a top rear perspective view of the second modified apparatus of FIG. 1H;

FIG. 1J shows a bottom front perspective view of a third modified apparatus for forming the puck of FIG. 1A;

FIG. 1K shows a top rear perspective view of the third modified apparatus of FIG. 1J;

FIG. 1L shows a bottom front perspective view of a fourth modified apparatus for forming the puck of FIG. 1A;

FIG. 1M shows a top rear perspective view of the fourth modified apparatus of FIG. 1L;

FIG. 1N shows a bottom front perspective view of a fifth modified apparatus for forming the puck of FIG. 1A;

FIG. 1O shows a top rear perspective view of the fifth modified apparatus of FIG. 1N;

FIG. 1P shows a bottom front perspective view of a sixth modified apparatus for forming the puck of FIG. 1A;

FIG. 1Q shows a top rear perspective view of the sixth modified apparatus of FIG. 1P;

FIG. 1R shows a bottom front perspective view of the puck of FIG. 1A;

FIG. 1S shows a top rear perspective view of the puck of FIG. 1A;

FIG. 2 is a top view simplified diagram of a cylindrical cavity in a cylinder head, called a cylindrical head cavity, in which the puck of FIG. 1A rotates, and general locations of a head exhaust port and a head intake port;

FIG. 3A is an exploded side view of a cylinder head, the puck of FIG. 1A, and the top portion of an engine block, showing a piston cylinder;

FIG. 3B is a simplified top view of the cylinder head of FIG. 3A showing locations of braking electromagnets;

FIG. 3C shows a bottom front perspective view of the puck of FIG. 1A, a bottom front perspective view of a ring for holding the puck onto the cylinder head of FIG. 3A, and an underside perspective view of part of the cylinder head of FIG. 3A, with the location of an exhaust port shown by dashed lines;

FIG. 3D shows a bottom front perspective view of the puck of FIG. 1A, a bottom front perspective view of a ring for holding the puck onto the cylinder head of FIG. 3A, and an underside perspective view of part of the cylinder head of FIG. 3A, with the location of an intake port shown by dashed lines;

FIG. 4A shows a top view of a distributor position sensing ring, a sensor arm, a solenoid, and a computer;

FIG. 4B shows a top view of a puck position sensing ring, a sensor arm, a solenoid, and a computer;

FIG. 4C shows a stepper motor shaft driving a gear train which in turn rotates a puck position sensing ring;

FIG. 5 is a top view simplified diagram of an alternative puck having scavenging veins in accordance with another embodiment of the present invention;

FIG. 6A is a top view of an outline of the puck in accordance with the embodiment of FIG. 5;

FIG. 6B is a side view of the puck of FIG. 5;

FIG. 7 is a side view of a swinging door on an intake manifold of an engine, such as an automobile engine, for use in an embodiment of the present invention;

FIG. 8 is a block diagram of a process and/or flow chart of a method, which can be programmed in and executed by the computer of FIG. 4.

### DETAILED DESCRIPTION OF THE DRAWINGS

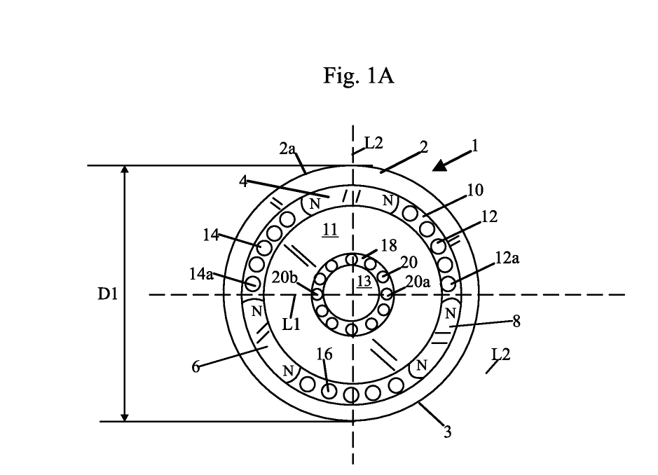

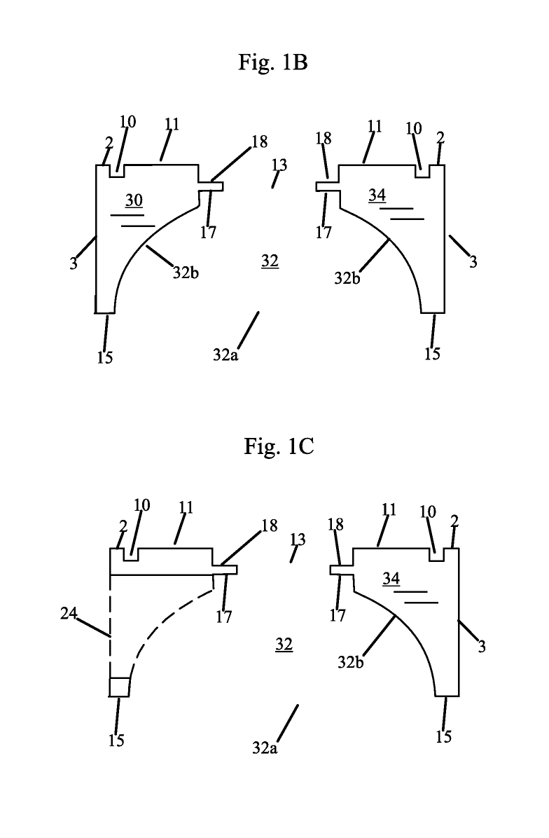

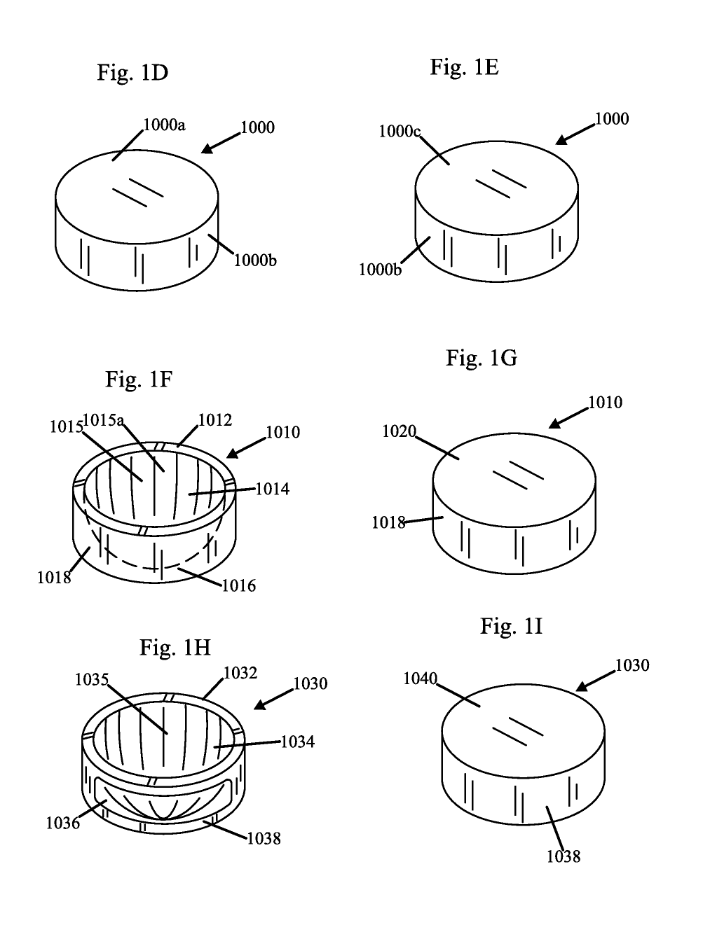

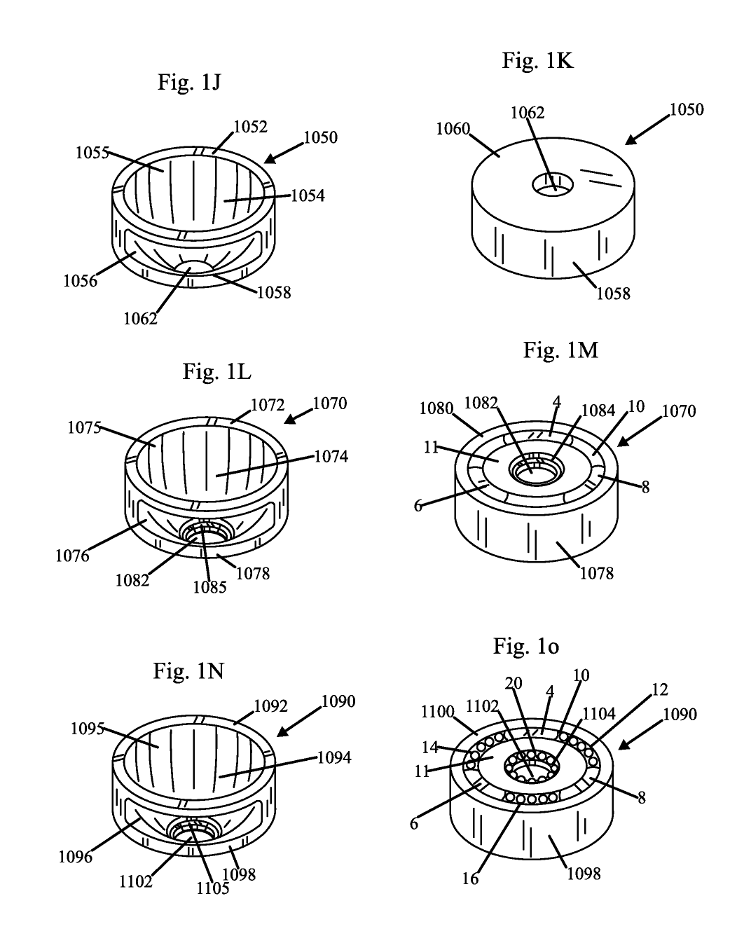

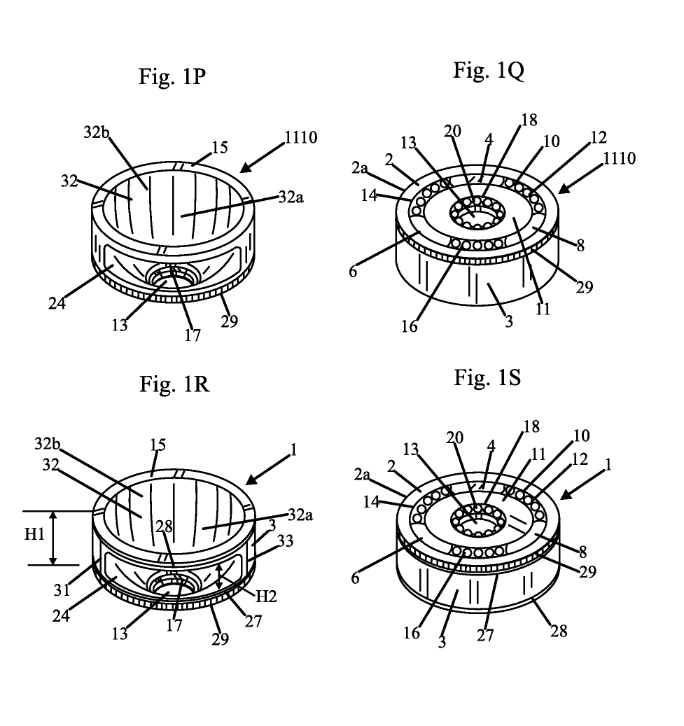

FIG. 1A is a top view of an apparatus, rotating valve, or which is called puck 1 in accordance with an embodiment of the present invention. The term “puck” was not previously in used in connection with engines, such as automobile engines, and the term “puck” has been coined by the present applicant. The puck body having combustion chamber 32 and puck port 24, gear teeth 29 around the top circumference, permanent magnets 4, 6 and 8, axle bearing 20, thrust bearings 10, 14 and 16, upper ring 28, lower ring 27 and ring type material 28e and 28f (Note 28, 27, 28e 28f 32, 24 29 are shown in FIG. 1R, not shown in FIG. 1A)

FIG. 1B is a side cross sectional view of the rotating valve or puck 1. In at least one embodiment, the puck 1 has a cylindrical outer shape, shown in FIG. 1A or peripheral surface 3 shown in FIGS. 1R and 1S; typically made of entirely or substantially of aluminum alloy, or may be made of a ceramic material having low coefficient of thermal expansion. To form the puck 1, a hemispherical opening may be cut into the bottom of the puck which is called the combustion chamber 32 whose location is shown by FIG. 1R. Typically the height of the combustion chamber 32 is on the order of 80% of the height H1, shown in FIG. 1R of the puck 1. The dimensions of the puck 1 depend on the application. As a rough ball park example, a four inch diameter D1 for puck 1 may have a height H1, shown in FIG. 1R on the order of three and a half inches tall. The combustion chamber 32 will be on the order of three inches in height from edge 15 to the bottom of the surface 32b of the chamber 32 next to step surface 17 near opening 13. The puck port 24, height H2, shown in FIG. 1R, would be on the order of two and three quarters inches, and the puck port 24 would take up one hundred and fifteen degrees of the circumference 2a of the puck 1 in at least one embodiment.

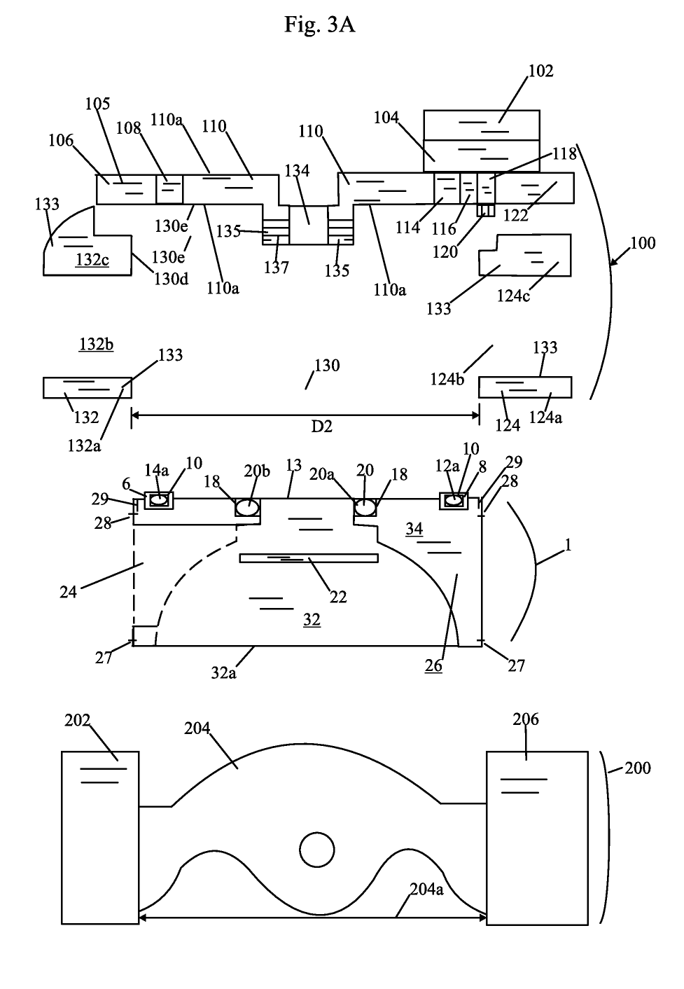

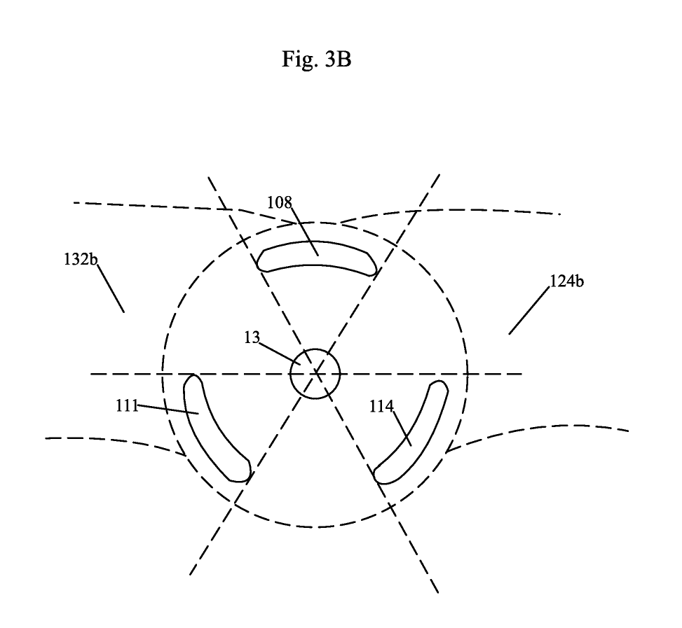

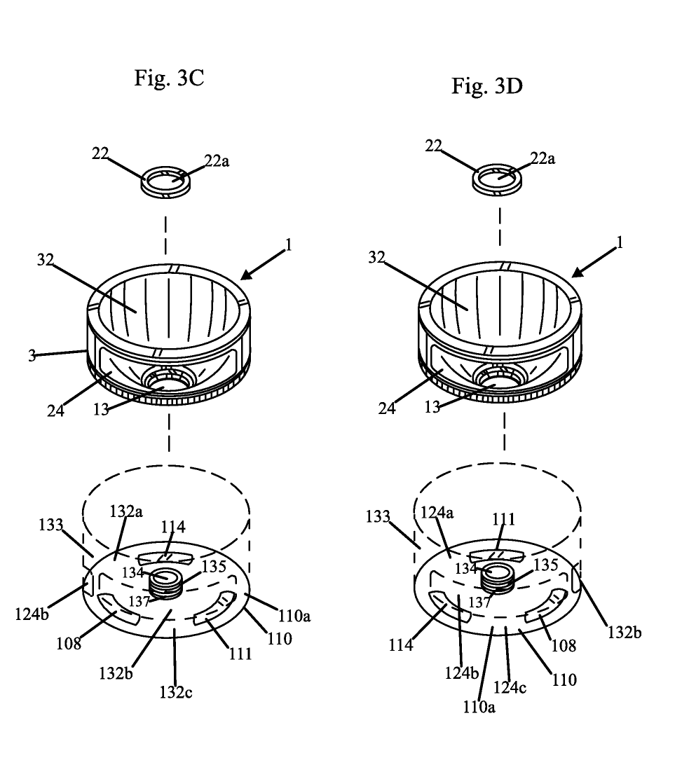

An opening, called a puck port 24, shown in FIG. 3, cuts through the side of the puck through to the combustion chamber 32. This opening takes up a little less than 120 degrees (e.g. 115 degrees) of the circumference 2a, shown in FIG. 1A of the puck 1. (Note: Puck port 24 is not shown in FIG. 1A). The top of the puck port 24 is close in height to the top of the combustion chamber 32, and the bottom of the puck port 1 is close to the bottom of the puck 1, as illustrated in FIGS. 1R and 1S. A round hole 13, shown in FIG. 1R is located through the top of the puck 1 and is open through to the combustion chamber 32. Material is removed around the hole 13 to allow for the installation of an axle bearing 20, shown in FIG. 1A in the top of the puck 1. Axle bearing 20 will be a sealed axle bearing in at least one embodiment. Note that the axle bearing 20 will be press fit into the top if the puck 1. Similarly, the inside of the axle bearing 20 will be press fit in pipe shaped section 135 of the cylinder head cover. Spaces and/or a channel 10, are located at the top of the puck 1 where permanent magnets 4, 6, and 8 are installed, as shown in FIG. 1A. These permanent Magnets 4, 6, and 8 are also called braking Magnets 4, 6, 8.

FIG. 1D shows a bottom front perspective view of an apparatus 1000 for forming the puck 1 of FIG. 1A. FIG. 1E shows a top rear perspective view of the apparatus 1000 of FIG. 1D. The apparatus 1000 may be a solid cylindrical mass and may be made of aluminum alloy or ceramic material The apparatus 1000 may have a bottom surface 1000a, a top surface 1000c, and a side or peripheral surface 1000b.

FIG. 1F shows a bottom front perspective view of a first modified apparatus 1010 for forming the puck 1 of FIG. 1A. FIG. 1G shows a top rear perspective view of the first modified apparatus 1010 of FIG. 1F. The first modified apparatus 1010 is formed from the apparatus 1000, by cutting a hemispherical indentation into the bottom surface 1000a of the apparatus 1000. A hemispherical indentation or chamber 1015 is formed having an opening 1014, and a curved inner surface 1016 shown by dashed lines, whose view is obscured by a solid peripheral surface 1018. The first modified apparatus 1010 has a peripheral edge 1012, outer peripheral surface 1018, an inner concave surface 1015a, and a bottom surface 1020. The first modified apparatus 1010 is substantially shaped like a bowl with a straight or substantially straight outer peripheral surface 1018, in at least one embodiment.

FIG. 1H shows a bottom front perspective view of a second modified apparatus 1030 for forming the puck 1 of FIG. 1A. FIG. 1I shows a top rear perspective view of the second modified apparatus 1030 of FIG. 1H. The second modified apparatus 1030 is formed from the first modified apparatus 1010 by cutting an opening 1036 in the peripheral wall or surface 1018, wherein the opening 1036 covers about one hundred and twenty degrees of the peripheral surface 1038 (which is the peripheral surface 1018 modified by the opening 1036). The opening 1036 goes into the chamber 1035. An opening 1034 leads to the chamber 1035. The second modified apparatus 1030 includes edge 1032 which is the same as edge 1012. The second modified apparatus 1030 includes top surface 1040.

FIG. 1J shows a bottom front perspective view of a third modified apparatus 1050 for forming the puck 1 of FIG. 1A. FIG. 1K shows a top rear perspective view of the third modified apparatus 1050 of FIG. 1J. The third modified apparatus 1050 is formed by cutting an opening 1062 into the second modified apparatus 1030 to form the third modified apparatus 1050. The third modified apparatus 1050 includes a top surface 1060 having the hole 1062. The third modified apparatus 1050 includes an edge 1052 (same as 1032), a chamber 1055, an opening 1054 leading to chamber 1055, opening 1056 (same as 1036) leading to chamber 1055, and peripheral surface 1058 (same as peripheral surface 1038).

FIG. 1L shows a bottom front perspective view of a fourth modified apparatus 1070 for forming the puck 1 of FIG. 1A. FIG. 1M shows a top rear perspective view of the fourth modified apparatus 1070 of FIG. 1L. The fourth modified apparatus 1070 is formed from the third modified apparatus 1050 by cutting out a portion near the hole 1062 on top surface 1060 and a portion below top surface 1060, and also by cutting out a channel 10 in the top surface 1060 and placing permanent magnets 4, 6, and 8 in the channel 10, with centers of adjacent magnets of magnets 4, 6, and 8 offset by one hundred and twenty degrees. The fourth modified apparatus 1070 includes an edge 1080, a channel 10, a surface 11, a step outer surface 1084, and an opening 1082. The fourth modified apparatus 1070 also includes permanent magnets 4, 6, and 8, peripheral surface 1078, a step inner surface 1085, a chamber 1075, an opening 1074 leading to the chamber 1075, an opening 1076 leading into the chamber 1075, and a bottom edge 1072.

FIG. 1N shows a bottom front perspective view of a fifth modified apparatus 1090 for forming the puck 1 of FIG. 1A. FIG. 1o shows a top rear perspective view of the fifth modified apparatus 1090 of FIG. 1N. The fifth modified apparatus 1090 is formed from the fourth modified apparatus 1070 by adding bearings 12, 14, and 16 into the channel 10 between the appropriate adjacent magnets as shown (i.e. bearings 12 between magnets 4 and 8, bearings 16 between magnets 8 and 6, and bearings 14 between magnets 4 and 6); and by adding bearings 20 on the step outer surface 1104 (same as step surface 1084). The fifth modified apparatus 1090 includes an edge 1100, the channel 10, the surface 11, the step outer surface 1104, and an opening 1102 (same as 982 I do not see 982). The fifth modified apparatus 1090 also includes permanent magnets 4, 6, and 8, peripheral surface 1098 (same as 1078), a step inner surface 1105 (same as 1085), a chamber 1095 (same as 1075), an opening 1094 (same as 1074) leading to the chamber 1095, an opening 1096 (same as 1076) leading into the chamber 1095, and a bottom edge 1092 (same as 1072).

FIG. 1P shows a bottom front perspective view of a sixth modified apparatus 1110 for forming the puck 1 of FIG. 1A. FIG. 1Q shows a top rear perspective view of the sixth modified apparatus 1110 of FIG. 1P. The sixth modified apparatus 1110 is formed from the fifth modified apparatus 1090 by forming gear teeth or protrusions 29 in a top portion of the peripheral surface 1098 to form a plurality of teeth 29 which are located at the top of a peripheral surface 3. The sixth modified apparatus 1110 includes an edge 2, the channel 10, the surface 11, the step outer surface 18 (same as 1104), and an opening 13 (same as 1102). The sixth modified apparatus 1110 also includes permanent magnets 4, 6, and 8, bearings 12, 14, and 16, bearings 20, peripheral surface 3, plurality of gear teeth 20, a step inner surface 17 (same as 1105), a chamber 32 (same as 1095), an opening 32a (same as 1094) leading to the chamber 32, an opening or port 24 (same as 1096) leading into the chamber 32, and a bottom edge 15 (same as 1092). The sixth modified apparatus 1110 has a circumference 2a.

FIG. 1R shows a bottom front perspective view of the puck 1 of FIG. 1A. FIG. 1S shows a top rear perspective view of the puck 1 or apparatus 1 of FIG. 1A. The puck 1 is formed from the sixth modified apparatus 1110 by adding peripheral rings 28 and 27 around the peripheral surface 3, and by adding straight members 31 and 33 shown in FIG. 1R. Grooves, not shown, may be cut into the peripheral surface 3 and the peripheral rings 28 and 27 and the straight members 31 and 33 may sit in the grooves, in the locations shown by FIGS. 1R and 1S.

The puck or apparatus 1 includes the edge 2, the channel 10, the surface 11, the step outer surface 18, the opening 13, the permanent magnets 4, 6, and 8, bearings 12, 14, and 16, bearings 20, peripheral surface 3, rings 27 and 28, straight members 31 and 33, the plurality of gear teeth 29, the step inner surface 17, the chamber 32, the opening 32a leading to the chamber 32, an opening or puck port 24 leading into the chamber 32, and a bottom edge 15. The puck 1 has a circumference of 2a.

Also located on the top of the puck 1 are thrust bearings 12, 14, and 16 in FIG. 1A. The bearings 12, 14, and 16 are typically installed in cutouts or channel 10 in the top of the puck 1 so that only the tops of the bearings, 12, 14, and 16, would protrude above the top of the puck 1. Note that the permanent magnets 4, 6 and 8 are shown sharing the same concentric space as the thrust bearings 12, 14 and 16. This is merely one embodiment. There is no reason why the thrust bearings 12, 14, and 16 need to be in the same concentric space. The thrust bearings 12, 14 and 16 can occupy an outer “orbit” than the braking magnets 4, 6, and 8, or visa versa. Thrust bearings can be one complete ring, instead of bearings 12, 14, and 16—this is the preferred embodiment since thrust bearings are most often ring shaped.

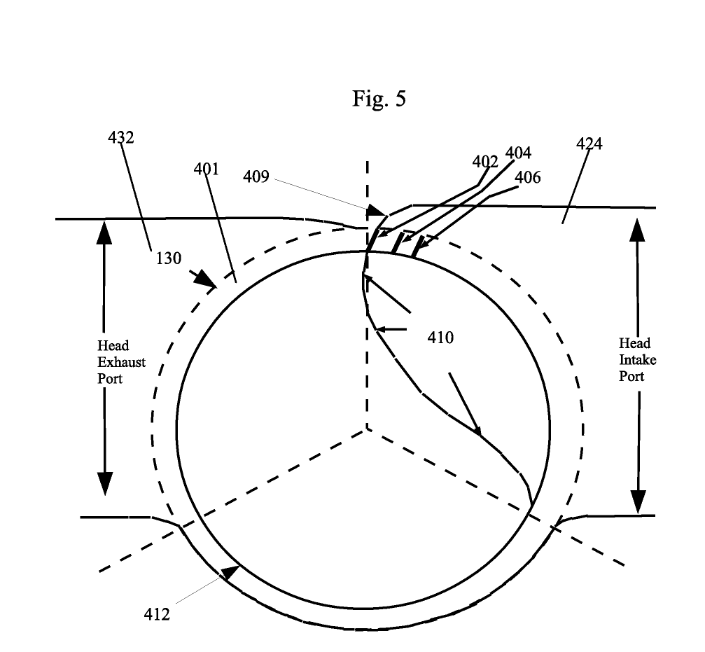

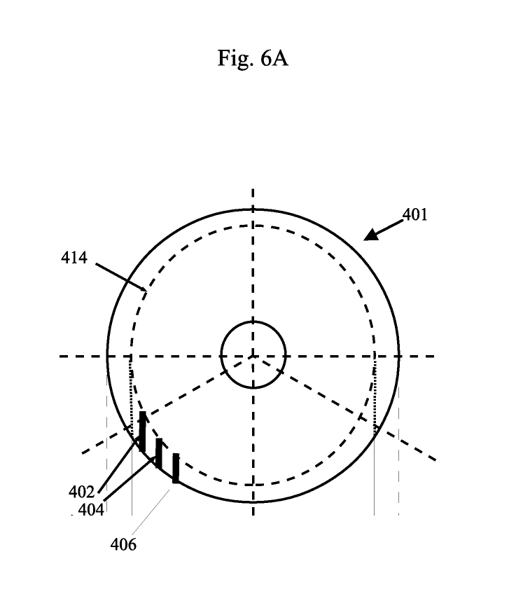

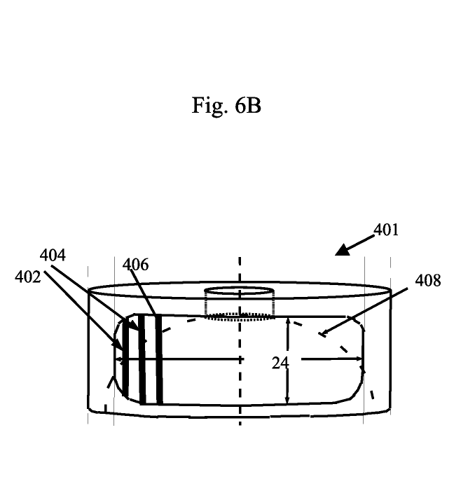

Later drawings will provide other features such as scavenging veins 402, 404, 406 that can be part of a modified puck 401, which is a modified form of puck 1. FIGS. 5, 6A and 6B show veins 402, 404, and 406, radius and cupped piston working together to optimize scavenging.

Located inside the cylindrical gap 10 are braking magnets 4, 6, and 8 and pluralities 12, 14, and 16 of thrust bearings. Bearings 12 include bearing 12a and bearings 14 including bearing 14a. Located inside the cylindrical gap or on step surface 18 is a sealed axle bearing 20.Note: an axle bearing is a well defined “off the shelf” part having a donut shape. Only one axle bearing, typically axle bearing 20, will be used on each puck 1.

FIG. 1B shows a cross section of part of the puck 1 if FIG. 1A if cut along the horizontal center line L1 shown in FIG. 1A. This drawing helps to illustrate the shape of the combustion chamber 32. The braking magnets 4, 6, and 8, thrust bearings 12, 14 and 16, and axle bearing 20 are not shown in FIG. 1B.

FIG. 1C shows a cross section of part of puck 1 of FIG. 1A if cut along the vertical dashed center line, L2 shown in FIG. 1A. FIG. 1C helps to illustrate the shape of the combustion chamber 32 and the puck port 24. The braking magnets 4, 6, and 8, thrust bearings 12, 14 and 16, and axle bearing 20 are not shown in FIG. 1C.

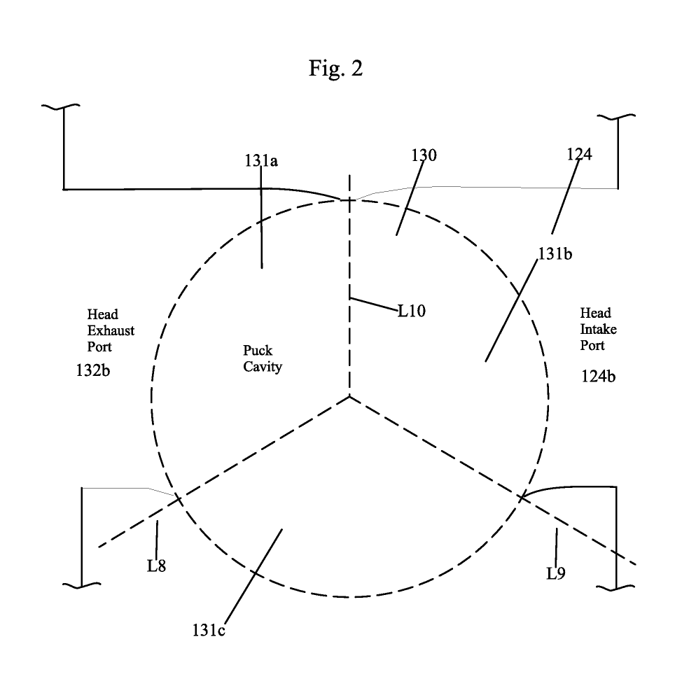

FIG. 2 is a top view simplified diagram of a cylindrical space 130 inside a cylinder head 100 shown in FIG. 3, called a cylindrical head cavity 130, in which the puck 1 of FIG. 1A is installed. The circumference of this cylindrical head cavity 130 may be considered to have three equally sized portions called “segments”, each taking up one hundred and twenty degrees of the circumference. These segments are shown as 131a, 131b, and 131c in FIG. 2. However, the segments 131a, 131b, and 131c are not divided by physical walls but rather are just described as being segments. The dashed lines L8, L9, and L10 do not represent physical walls, but simply show the three one hundred and twenty degree portions.

The upper right segment 131b is an intake port 124b of the cylinder head 100 shown in FIG. 3. The intake port is a good size, nearly one hundred and twenty degrees of the circumference of the cylindrical cavity 130. The upper left segment 131a is an exhaust port 132b of the cylinder head 100 also nearly one hundred and twenty degrees of the circumference of the cylindrical cavity The third segment 131c comprising the bottom third of the cylindrical head cavity 130 is called the compression segment 131c and it has no opening.

FIG. 3A is an exploded cross sectional side view of the cylinder head 100, the puck 1; and a top portion of an engine block, such as an automobile engine block, containing a top portion of a piston cylinder 200 and domed piston 204 in a cylinder bore 204a. The cylinder head 100 as shown by FIG. 3, includes a removable cover 105. The removable cover 105 includes portions 106, 108, 110, 110a, 112, 114, 116, 122 and 135. The cylinder head 100 also includes the head exhaust port 132b and head intake port 124b. The portions 132a and 132c are part of the metal of the cylinder head 100, below and above, respectively, the exhaust port 132b. Similarily 124b represents the head intake port—an open space, while 124a and 124c are part of the metal of the cylinder head 100 below and above the intake port 124b. The cylinder head 100 also includes the cylindrical cavity or cylindrical head cavity 130.

The cylinder head 100 also includes a cylindrical hole 134 for a spark plug. Typically the hole 134 has internal threads for screwing in a spark plug, but threads are not shown in FIG. 3. Installed in the cylinder head are: a sensing ring device called the puck position sensing ring 102, stepper motor 104, with its shaft 118 and pinion gear 120 shown in FIG. 3A.

FIG. 3A also shows the puck 1. As shown by FIG. 3, the puck 1 includes puck port 24, combustion chamber 32, sleeve 22. The puck 1 also includes sealing rings 27, 28, sealing parts or members 31 and 33, and puck gear teeth 29 which engage with the stepper motor pinion gear 120.

FIG. 3A also shows top portion 200 of an engine block of an engine, such as an automobile engine. The top portion 200 includes a piston cylinder 204 and engine block 202 and 206, as well as piston cylinder bore 204a and piston 204 for an engine such as an internal combustion engine used in automobiles and trucks, and other vehicles.

In at least one embodiment of the present invention, each of a plurality of pucks, each similar or identical to the puck 1 shown in FIG. 1A, is placed in a cylindrical head cavity 130 in a cylinder head 100, similar or identical to cylindrical head 100 shown in FIG. 3, located above a piston cylinder in an engine, such as an automobile engine. Thus, there are a plurality of pucks, similar or identical to the puck 1, one for each piston cylinder, with one puck installed above each piston cylinder. For example, a V8 or V6 or V2 engine typically has two cylinder heads and eight, six, or two pistons, respectively. One puck (analogous to puck 1) is provided for each piston, so there would be eight pucks for eight pistons for a V8 engine and six pucks for six pistons for a V6 engine etc. An inline engine generally has one cylinder head and one puck 1 for each piston cylinder.

The puck 1 of FIG. 1A has a generally cylindrically peripheral wall or surface or outline 3 shown in FIG. 1S. The puck 1 is installed in a substantially or entirely cylindrically shaped cavity in the cylinder head 100, called the “cylindrical head cavity” 130 shown in FIG. 3. The puck 1 is caused to rotate in the cylindrical head cavity 130 by a stepper motor 104 which is controlled by a computer 340. The stepper motor 104 causes stepper motor shaft 118 and pinion gear 120 to rotate. Pinion gear 120 engages plurality of gear teeth 29 which cause puck 1 to rotate. The gear teeth 29 are all the way around the circumference 2a of puck 1 at the top of the puck 1 as shown by FIGS. 1R and 1S

The chamber 32 is typically a substantially hemispherical shaped chamber or an entirely hemispherical shaped chamber in the puck 1. The chamber 32 is the combustion chamber and it is shown in FIG. 1R There is an opening 32a, shown in FIG. 1R and in FIG. 3A, in the bottom of the puck 1 which leads to the combustion chamber 32. This opening 32a, in at least one embodiment, is a circular or substantially circular opening, which has a diameter which may be the close to but smaller than D1, the diameter of the puck 1, shown in FIG. 1A. There is an opening or puck port 24, shown in FIG. 3A and in FIG. 1R, through the peripheral wall or surface 3 in the side of the puck 1 that connects through to the combustion chamber 32. In at least one embodiment, the puck port 24 takes up nearly ⅓rd of the puck circumference 2a (one hundred and fifteen degrees), thus providing a relatively large opening.

The stepper motor 104 shown by FIG. 3, as commanded by the computer 340, quickly rotates the puck 1 to align the puck port 24 to the cylinder head intake segment 124b at the start of the intake stroke, i.e. to align the puck port 24 with the cylinder head Intake port portion 124b of the head. The piston intake stroke draws fuel air mixture through the cylinder head intake 124b, through the puck port 24 and combustion chamber 32 into the piston cylinder 204a during the intake stroke. Near the start of the piston compression stroke, the puck 1 is then rotated by the stepper motor 104 (by stepper motor rotating shaft 118, turning pinion gear 120 which interacts with gear teeth 29 shown in FIG. 1R, to cause rotation of the puck 1) to the compression segment 131c in FIG. 2 where the puck 1 remains at a rest orientation or angular position for the compression and power strokes. The puck port 24 is aligned with the compression segment 131c, which has no opening. This is analogous to both intake and exhaust valves being closed in a conventional engine, Finally, the stepper motor 104 rotates puck 1 to align the puck port 24 with the head exhaust port 132b for the exhaust stroke. Exhaust gases exit the piston cylinder through the combustion chamber 32, through the puck port 24, and through the head exhaust port 132b into the exhaust manifold. This process is repeated by rotating the puck 1 to align puck port 24 with the cylinder head intake port 124b at the start of the next intake stroke.

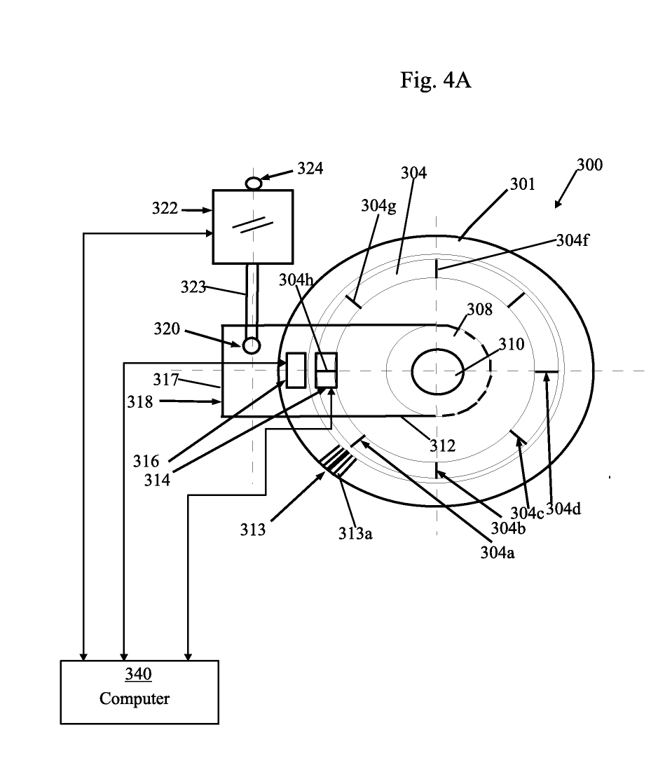

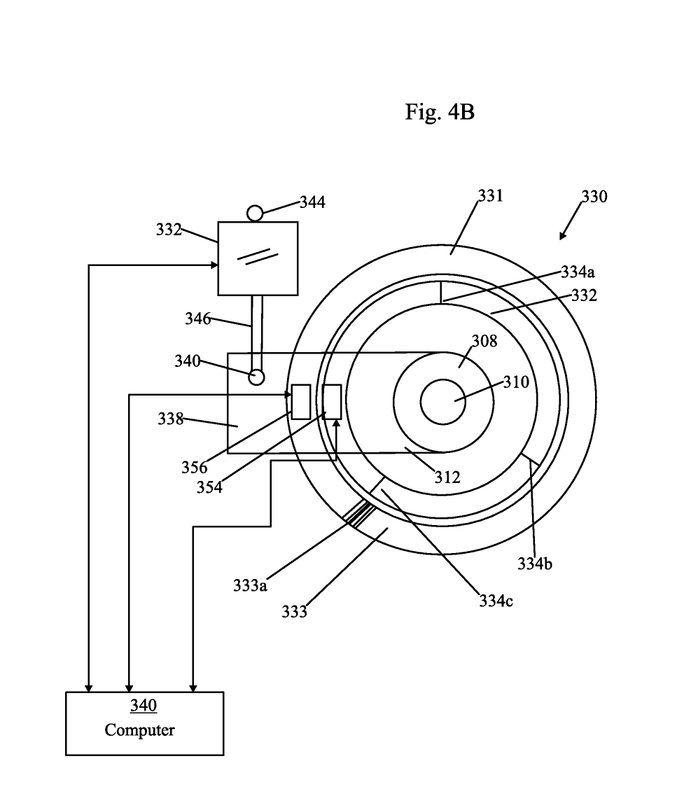

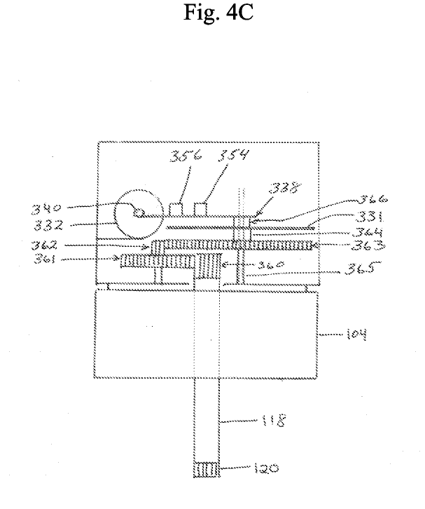

An axle bearing 20 is installed between cylindrical member 135 in FIG. 3 and the top of the puck 1. Thus cylindrical member 135, shown in FIG. 3, serves as the axis of rotation of the puck 1. The computer 340 is programmed to send a signal to cause stepper motor 104 to drive pinion gear 120 via shaft 118. The Pinion gear 120 engages with gear teeth 29 that can be in one embodiment machined around the top circumference 2a of the puck 1. In an alternative embodiment, a gear, being a separate part could be installed on the puck in a step groove designed to accept the gear. Generally the gear teeth 29 do not extend beyond the circumference of the puck 1. Thus the stepper motor 104 rotates the puck 1 under computer control of the computer 340 shown in FIGS. 4A and 4B.

The puck 1 serves as an intake valve in one position (when the puck port 24 is aligned with the portion 124b of the head intake port), and the exhaust valve in another position (when the puck port 24 is aligned with the portion 132b of the head exhaust port) resulting in a large “valve” opening—typically twice that of conventional valves. Additionally, The use of three segments shown in FIG. 2 permits the width of the puck port 24 to be nearly one hundred and twenty degrees, thus achieving the large port size.

FIG. 3C shows a bottom front perspective view of the puck 1 of FIG. 1A, a bottom front perspective view of a ring or sleeve 22 for holding the puck 1 onto the cylinder head 100 of FIG. 3A, and an underside perspective view of part of the cylinder head 100 of FIG. 3A, with the location of an exhaust port 132b shown by dashed lines. FIG. 3D shows a bottom front perspective view of the puck 1 of FIG. 1A, a bottom front perspective view of the ring or sleeve 22 for holding the puck 1 onto the cylinder head 100 of FIG. 3A, and an underside perspective view of part of the cylinder head 100 of FIG. 3A, with the location of an intake port 124b shown by dashed lines.

Note that, as previously described, axle bearing 20 is pressed into the puck 1 and is press fit onto 135. Therefore the axle bearing 20 is the primary means of securing the puck 1 into the cylindrical head cavity 130, in at least one embodiment. Sleeve 22, in one embodiment is an added safety precaution to keep the puck 1 from coming loose.

FIG. 3C shows the sleeve 22 having an opening 22a, and the puck 1. FIG. 3C also shows an underside 110a of the body portion 110 of the cylinder head 100, also shown in FIG. 3A. FIG. 3C also shows by dashed lines, the location of peripheral wall 133, of the cylinder head 100. The peripheral wall 133 has an exhaust opening 132b shown by dashed lines in FIG. 3C. The electromagnets 114, 111, and 108 are also shown in FIG. 3C. Part of intake port 124b is shown by dashed lines in FIG. 3C. In addition member 135, which is an axle or axis that puck 1 rotates about when puck 1 is placed within the peripheral wall 133 of cylinder head 100, is shown. Opening 134 through member or tube 134 is also shown in FIG. 3C. In operation the puck 1 may be placed within the cylinder head 100 such that peripheral wall 3 of the puck 1 lies within the peripheral wall 133 of the cylinder head 100, and such that member 135 is inserted into the opening 13 of the puck 1. The sleeve 22 then can be used to hold puck 1 on the cylinder head 100 by being screwed onto outer threads 137 shown in FIG. 3C of the member 135. The sleeve 22 may be a nut. The puck 1 is mounted to the member 135 so that the puck 1 can rotate about member 135 and so that the edge 2 of the puck shown in FIG. 1S is closely adjacent to the underside 110a shown in FIG. 3C of the cylinder head 100. After the puck 1 is mounted to the member 135 by the sleeve or nut 22 being threaded or screwed onto member 135 and threads 137, so that the underside 110a of the cylinder head 100 is closely adjacent to the edge 2 of the puck 1, the puck 1 can be rotated about the member 135 by electromagnets 108, 111, and 114 to cause alignment of the puck port 24 with the exhaust port 132b shown in FIG. 3C, or to cause alignment of the puck port 24 with the intake port 124b shown in FIG. 3D, or to cause alignment with neither the port 124b or 132b, but rather blockage of the puck port 24 by the peripheral wall 133. Note that bearings 14, 12, and 16, shown in FIG. 1S protrude above the edge 2 to prevent the edge 2 and surface 11 in FIG. 1S from rubbing against the underside 110a shown in FIG. 3C and 3D of the cylinder head 100. The bearings 14, 12, and 16 which actually make contact with the underside 110a of the cylinder head 100.

In at least one embodiment of the present invention continuously variable valve timing is provided. The computer 340 controls the stepper motor 104 to vary the start of rotation and the timing of the rotation of the puck 1 to achieve the benefits of continuously variable valve timing without mechanical complexity. Generally known methods or concepts of continuously variable valve timing (CVVT) or variable valve timing (VVT) are known to those skilled in the art, however one or more embodiments of the present application provide new methods of CVVT and VVT.

In at least one embodiment of the present invention, the computer 340 can cause some of the piston cylinders (not shown) of an engine, such as an automobile engine, to be disengaged when an automobile, or other vehicle, is cruising at a constant speed, or at idle or at any other time, for substantial fuel savings. This can be accomplished under control of the computer 340 with minimal mechanical complexity. One or more embodiments of the present invention allow the engaging and disengaging of pistons to be accomplished very quickly and in a seamless manner. Thus, for example, a car can function as a fuel efficient four cylinder, but when a driver depresses the accelerator in at least one embodiment, the engine will automatically transform to full power mode V8 by re-engaging pistons.

In at least one embodiment of the present application, cars can be equipped with a (dashboard) switch or otherwise selectable option, that allows the car to operate in fuel efficient mode only, or switched to a “POWER” mode in which the car automatically switches from fuel efficient mode to full power mode when the accelerator is depressed. This feature could be equipped with a password or other method such that only authorized drivers can access the “power” mode, for example, dad may not want his teenage son accessing the power mode, only the fuel efficient mode.

One or more embodiments of the present invention eliminate the need for a cam shaft, push rods, lifters, rockers, valves, valve springs, timing chain or timing belt, timing gears, which are typically used in known engines, such as automobile engines, thus greatly increasing reliability and reducing cost to manufacture, the engine, such as an automobile engine.

One or more embodiments of the present invention provide a noninterference engine without sacrificing compression ratio.

The puck 1 has a generally cylindrical outline and a cylindrical outer peripheral surface 3 shown in FIGS. 1R and 1S, with at least the exception of port opening 24. The geometry of the combustion chamber 32 of the puck 1 is typically hemispherical similar to a hemispherical combustion chamber of a “hemi-engine” which is known in the art. However, the chamber 32 may take on any other shape that is suitable for a specific purpose. In one or more embodiments of the present invention a large puck port 24 needs to transition into the combustion chamber 32 to maintain high flow. As a result, the combustion chamber 32 needs to be relatively tall, and therefore have more volume than typical combustion chambers in conventional engines. In order to achieved a desired compression ratio, a domed piston 410 may be used in one embodiment of the present invention. Generally speaking a “domed” piston is known in the art.

The rotating puck 1 functions as a valve. The rotating puck 1 serves as both an intake valve and an exhaust valve for an engine, such as an automobile engine. By doing so, the size of the valve opening can be greatly increased relative to traditional known devices that use two or more separate valves.

In at least one embodiment, the puck 1 is quickly rotated, by the computer 340 through the stepper motor 104, at appropriate times in an engine cycle. During the remainder of the time of the engine cycle, after the puck 1 has been rotated, the puck 1 remains at a rest orientation (does not rotate). There are three “rest” angular positions or orientations for the puck 1, which correspond to the three segments 131a, 131b, and 131c shown in FIG. 2: For the intake rest position—the puck port 24 is aligned with intake port 124b, the compression rest orientation when the puck port 24 is aligned with the compression segment 131c, and the exhaust rest angular position or orientation, when the puck port 24 is aligned with the exhaust port 132b.

Referring to FIG. 1A and FIG. 2 the puck 1 can be rotated either two thirds of a turn counterclockwise, or one third of a turn clockwise, in order to change the alignment from the exhaust port 132b to the intake port 124b. In the case where the rotation is one third of a turn clockwise, there will be an open path from the head intake port 124b, to the head exhaust port 132b while the puck 1 is rotated. This operation supports scavenging. In the case where the rotation is two thirds of a turn counterclockwise, no path opens between the intake port 124b and the exhaust port 132b. This is better for emissions and fuel economy since none of the intake fuel air mixture from the head intake port 124b can be drawn into the exhaust manifold or exhaust port 132b.

Because of the computer control of the stepper motor 104 by the computer 340, the timing of the rotation of the puck 1 can be varied for optimizing such factors as fuel efficiency, horsepower, reduced emissions, and scavenging. This timing can be easily varied by the computer 340 over the RPM (revolutions per minute) range. For example, during acceleration, horsepower can be optimized, while at cruising speed or idle, fuel efficiency and reduced emissions can be optimized. The normal driver only occasionally operates a vehicle in acceleration mode (full power) a small percentage of the time, however, fast acceleration is desirable. One or more embodiments of the present invention permit the car to perform as a fuel efficient four cylinder when cruising or idling, and turn into a powerful eight cylinder engine when the accelerator is pressed.

It should be noted that FIG. 2 would have the intake of a fuel air mixture entering the cylinder head 100 from the right of FIG. 2 (through head intake port 124b), and the exhaust exiting to the left of FIG. 2 (through the head exhaust port 132b). This would apply, for example, to the right bank of pistons on a V8 automobile engine, as viewed from the front of the car. The FIG. 2 drawing could be flipped about the vertical center line, so that intake would be on the left and exhaust on the right as would apply to the left bank of pistons on a V8 automobile engine. Similarly, FIG. 2 shows the intake and exhaust at the top, which would apply to the front cylinders on a V8 automobile engine. FIG. 2 could be flipped about the horizontal center line such that the intake and exhaust would be at the bottom of FIG. 2, which would apply to rear cylinders of a V8 automobile engine. One or more embodiments of the present invention thus encompass all possible orientations.

The puck 1 has a diameter, D1 shown in FIG. 1A, which will typically be close to the diameter of a piston cylinder of an engine in which the puck 1 is installed. A puck diameter, D1, larger than the piston cylinder permits a larger puck port 24 size Similarly, A taller or thicker puck 1 will permit a larger puck port 24 size.

In one or more embodiments, the intake port 124b in a typical intake manifold, and in the cylinder head 100 would typically be increased to equal the size of the puck port 24 shown in FIG. 1R in order to take full advantage of the larger port size afforded by this invention. Similarly, the port size of the exhaust port 132b in the cylinder head 100 and the size of the exhaust manifold should be increased to equal the size of the puck port 24 in order to take full advantage of the larger port size afforded by this invention.

The puck 1 is held in place in the cylindrical head cavity 130 in the cylinder head 100, for example, by a sleeve 22, that is larger than the hole 13 in the puck 1, which is threaded around the pipe shaped portion 135 of the head 100, or by a washer and spring clip in a groove around pipe shaped portion 135, or by any other suitable means.

The cylinder head 100 could be provided with a removable cover 105 over each cylinder or bank of cylinders that would allow the puck 1 to be serviced or replaced without having to remove the entire cylinder head 100. FIG. 3A shows such a removable cover 105. In at least one embodiment, the removable cover 105 may include or may consist of components, 106, 110, 110a, 135, 112, 116, and 122, and may further include contains braking electromagnets 108 and 114, and a third braking electromagnet 111 not shown in FIG. 3B.

The cylinder head 100 has passages not shown in FIG. 3A for coolant and lubrication as is done with conventional heads.

In at least one embodiment, the puck 1 rotates inside the cylindrically shaped cavity 130 by any means, for example, by an electric motor or stepper motor such as 104, by magnets and electromagnets, all controlled by the computer 340. An electric motor may provide a lower cost, less complex solution. The stepper motor 104 is the preferred solution because the precise computer control allows tuning for optimum performance, fuel economy and emissions.

An important feature of one or more embodiments of the present invention is computer control of the orientation and rotation of the puck 1.

The diameter of the stepper motor shaft 118 may be made slightly larger than the pinion gear 120 to allow removal of the stepper motor 104 for service or replacement, without having to remove the cylinder head 100 or cylinder head cover, which may be comprised of or may consist of components 105, 106, 110, 110a, 135, 112, 116, and 122, and contains braking electromagnets 108, 111 (shown in FIG. 3B) and 114. The small pinion gear 120 (typical diameter ¼ to ⅜ inches, having six to ten teeth) driving the large puck 1 (typical diameter, D1, is three and one half to four inches and having typically three hundred teeth for gear teeth 29 around circumference 2a, shown in FIGS. 1R and 1S, gear transfers maximum torque, allowing a relatively smaller (lower cost) stepper motor 104.

One embodiment of this invention is to use large powerful stepper motors for the stepper motor 104. In such an embodiment, braking magnets and braking electromagnets (described later), such as 108 and 114, and 111 shown in FIG. 3B, may not be needed.

Unless a large, powerful stepper motor for stepper motor 104 is used, it may, in one or more embodiments, be ineffective at decelerating the rotation of the puck 1 as it approaches the new rest angular position or orientation If this were to happen, the angular momentum of the rotating puck 1 could overcome the stepper motor 104, causing its shaft 118 to turn independently. This could result in the puck orientation or angular position being different from what the computer 340 “thinks” it is in. One solution in accordance with one or more embodiments, is to use electromagnetic braking by using magnets 4, 6, and 8 shown in FIG. 1A and electromagnets 108, 114 and a third electromagnet 111, as described in the next section. (Note, FIG. 3B shows a top view of the head 100 showing the position of the three braking electromagnets 108, 111, and 114.) The stepper motor 104 will accelerate the puck 1, and the electromagnetic brakes 108, 114 and a third electromagnet 111 attract magnets 4, 6, and 8 and would stop the rotation of the puck 1 at the new orientation or angular rest position.

In at least one embodiment of the present application, there are three permanent braking magnets, 4, 6, and 8 installed on top of the puck 1, shown in FIG. 1A, equally spaced one hundred and twenty degrees apart. There are three braking electromagnets (108, 114, 111 shown in FIG. 3B) installed in the cylinder head 100 cover above each puck 1. The braking electromagnets 108, 114, 111, and the puck braking magnets 4, 6, and 8 will be in alignment whenever the puck 1 is in any of the three rest angular positions or orientations. Thus, the computer 340 can energize these three braking electromagnets 108, 111, and 114,—so as to attract the puck braking magnets 4, 6, and 8—as the puck 1 approaches any rest orientation or angular position. This will stop, and will hold the puck in the rest orientation or angular position.

Because of the one hundred and twenty degree symmetry, in at least one embodiment, there may be only one braking electromagnet along with three puck permanent magnets 4, 6, and 8, (or conversely, one puck magnet with three braking electromagnets 108, 114, and 111, shown in FIG. 3B. Using three permanent magnets 4, 6, 8 and three braking electromagnets 108, 111, 114, makes braking more robust and is preferred. Because of the angular momentum of the rotating puck 1, robust braking may be needed in one or more embodiments.

In at least one embodiment of this invention there may be a variety of different magnet/electromagnet configurations, such as for example, six braking magnets and six braking electromagnets. This invention shall encompass all configurations of puck magnets and head electromagnets.

When the next puck 1 rotation is initiated, the computer 340 is programmed by computer software to turn off electrical current to the braking electromagnets 108, 111, and 114, and turn on the stepper motor 104 to rotate the puck 1.

The computer 340 is provided with orientation feedback regarding the orientation or rotational position or angular position of the puck 1 through the data supplied to it from the puck position sensing ring 102. The computer 340 may use the orientation feedback to determine when to energize the braking electromagnets 108, 111, and 114.

The computer 340 uses the data from the puck position sensing ring 330 to determine when to energize the braking electromagnets, as the puck 1 approaches the rest angular position or orientation. As an alternative embodiment of this invention, the computer can determine the correct time to energize the braking electromagnets simply by counting the number of rotations of the stepper motor 104 since the last puck rest angular position or orientation. For example, if the puck 1 had three hundred gear teeth 29 around the top of its circumference 2a, and the stepper motor pinion gear 120 had ten teeth, then the puck shaft 118 would rotate ten times in order to rotate the puck one hundred and twenty degrees from one rest angular position or orientation to the next. Since computer 340 is initiating rotation of stepper motor 104, it will know when the tenth revolution was approaching and thus when to energize the braking electromagnets 108, 111, and 114. It may be beneficial for computer 340 to turn off all electrical current to the stepper motor when the braking electromagnets 108, 111, and 114 are energized. Note also that the magnets 4, 6, and 8, as well as the electromagnets 108, 111, and 114 each take up sixty degrees, in at least one embodiment Therefore, the computer 340 could energize the electromagnets 108, 111, and 114 early (as they start to overlap). The attraction of the magnets 4, 6, and 8 to the electromagnets 108, 111, and 114 would pull the puck 1 into the rest orientation or angular position.

FIG. 4A shows a top view of an apparatus 300 in accordance with an embodiment of the present invention. The apparatus 300 includes a distributor sensing ring 301 which is a round disk that is attached to the distributor shaft and rotates with it. The ring 301 has two concentric rings 313 and 304 which contain markings, such as 313a comprised of dark lines (e.g. black lines) against a light (e.g. white) background, similar to a bar code. These markings are sensed by optical sensors 314 and 316 which convert the dark and light lines into “ones” and “zeros” that are read by computer 340 as the sensing ring 301 rotates. The markings are encoded with “data” that the computer 340 uses to determine the distributor shaft position. From the distributor shaft position, the computer 340 can determine the position and stroke (intake stroke, compression stroke, Power stroke or Exhaust stroke) of all pistons in the engine using a lookup table.

The ring of lines 313 consisting of lines 313a go all the way around disk 301. FIG. 4A does not show these lines going all the way around disk 301 so as not to clutter the drawing. There are of course many ways to sense position on a rotating disk: optical, magnetic, laser etc. Similarly, there are many ways in which data may be encoded into patterns that the computer 340 can decode to determine the position of the rotating disk 301 of the rings 313 and 304. This example presents one of the many possible ways of encoding the data, and presents an optical method of reading the encoded data, and the present invention is not limited to this example.

The ring 304 includes encoded data lines 304a, 304b, 304c, 304d, 304e, 304f, 304g, and 304h. These eight lines are presented in the embodiment of this invention as an example where the engine is an eight cylinder engine. A six cylinder engine would have six equally spaced lines, and a four cylinder engine would have four equally spaced lines, etc.

The ring 313 includes the encoding shown in Table 1.

FIG. 4A shows sensor device 318 including sensor arm 317 and optical sensors 314 and 316 which may be fixed to the sensor arm 317. The optical sensors 314 and 316 may be in communication with and provide signals and/or data to a computer 340. The computer 340 may include computer memory, a user interactive device such as a computer mouse, keyboard, and/or touchscreen, a computer display, and a computer processor. The computer 340 referred to in one or more embodiments of the present invention may alternatively, and preferably be a circuit or module that performs tasks normally associated with a computer, but may not have a user interface such as a screen, keyboard or mouse (except for a diagnostic port used in development or for diagnostic purposes). The apparatus 300 of FIG. 4 also includes solenoid 322 connected to pivot pin 324 which is connected to arm 323, which is connected to pivot pin 320 which connects to the sensor arm 317.

The computer 340 uses the data obtained from the markings 304a-h by the optical sensors 314 and a look up table stored in computer 340 to determine piston stroke and position data. The computer 340 uses this information to determine when to initiate rotation of the puck 1, as well as other functions such as determining the speed of the engine (RPMs) etc.

In one or more embodiments, it may be beneficial to be able to read the distributor sensing ring 301 without rotating the engine. This could be accomplished in the following manner: FIG. 4 shows sensing arm 317. This arm is installed about the distributor shaft 310, so that the distributor shaft 310 is free to rotate, for example, when the engine is running. Sensing arm normally remains stationary. At times, such as when the engine is not running, the solenoid 322 may be energized under control of computer 340. Energizing solenoid 322 will cause the sensing arm 317 to rotate a few degrees about the distributor shaft 310. In so doing, the computer 340 will be able to read the data of sensing ring 313, such as data 313a, via sensor 316, that is contained in table 1. This provides a way for the computer 340 to determine the position and stroke of all pistons in the engine when the engine is not running.

### Distributor Sensing Ring 301 Encoding:

For example, when an installed on a V8 engine, such as a V8 automobile engine, the distributor sensing ring 301 could be encoded with an encoded bit stream of 1's and 0's as shown in Table 1 below:

TABLE 1
Distributor Sensing Ring 301 Encoding for Eight Cylinder Engine

| | | | | | | | |
|---|---|---|---|---|---|---|---|
| 10101 | 00000 | 10101 | 00001 | 10101 | 00010 | 10101 | 00011 |
| 10101 | 00100 | 10101 | 00101 | 10101 | 00110 | 10101 | 00111 |
| 10101 | 01000 | 10101 | 01001 | 10101 | 01010 | 10101 | 01011 |
| 10101 | 01100 | 10101 | 01101 | 10101 | 01110 | 10101 | 01111 |
| 10101 | 10000 | 10101 | 10001 | 10101 | 10010 | 10101 | 10011 |
| 10101 | 10100 | 10101 | 10101 | 10101 | 10110 | 10101 | 10111 |
| 10101 | 11000 | 10101 | 11001 | 10101 | 11010 | 10101 | 11011 |
| 10101 | 11100 | 10101 | 11101 | 10101 | 11110 | 10101 | 11111 |

There is a pattern 10101 that repeats in Table 1 above for every other group of bits. This pattern is used by the computer 340, in at least one embodiment, to sync on the encoded bit stream shown in Table 1. There are groups of five bits, between each sync pattern, which is the data. The group of data bits may be called a “word” The data is simply counting in binary. Converting to decimal, the data is 0, 1, 2 . . . . There are spaces in the bit stream of Table 1 which are used to make this description easier to understand. There will be no spaces in the actual bit stream. The data in table 1 is presented as an example. As mentioned, there are many ways in which information may be encoded. For example, five bits of data are shown comprising a word of data. A greater or lesser number of bits could be used for a word of data. Using six data bits would result in doubling the number of data words to sixty four, which provides twice the resolution of the distributor shaft position. In at least one embodiment of the present invention, “1”s in Table 1 may be represented by a black line on the ring 313 or 304 in pattern similar to a bar code, such as 313a, while “0'”s in Table 1 may be represented by a white line on the ring 301 in pattern 313a, for example shown in FIG. 4A. Two ones in a row would mean a black line twice as thick, etc. As the distributor sensing ring 301 rotates, the computer 340 will convert the signal or signals coming from the sensors 314 and 316 to a series of ones and zeros (the basic language the computer 340 understands).

FIG. 4B shows an apparatus 330 called the puck position sensing ring. As can be seen, it bears similarity to the distributor position sensing ring 301 shown in FIG. 4A, though there are differences.

FIG. 3A identifies the location of sensing ring and gears 102 on top of the stepper motor 104. A side view of 102 is shown in detail in FIG. 4C. The stepper motor 104 makes many revolutions for one revolution of the puck 1. In at least one embodiment, the gear train shown in FIG. 4C is installed on top of the stepper motor 104, connecting to the stepper motor shaft 118. The gear train gears down the multiple rotations of the stepper motor shaft 118, so as to rotate a puck position sensing ring similar to 304 shown in FIG. 4A, that makes one revolution for each rotation of the puck 1. The puck position sensing Ring 331 will be similar to the distributor position sensing ring 301, but the puck position sensing ring 331 will have the outer ring 333, having marking like marking 333a encoded as shown in a Table 2. The stepper motor 104 could be provided with the sensor arm 338 and solenoid 332 shown in FIG. 4B to enable the puck position sensing ring 331 to be read without rotating the puck 1.

FIG. 4C is a side view showing gear train consisting of gears 360, 361, 362 and 363 and the Puck Position Sensing Ring 330 consisting of disk 331, solenoid 332, pivot 340, sensor arm 338, and optical sensors 354 and 356. The shaft 118 of stepper motor 104 has pinion gear 120 which engages with gear teeth 29a and 29b, and similar or identical gear teeth that go all the way around the top of puck 1. The small pinion gear 120 will make many turns for one turn of the puck 1. A pinion gear 360, shown in FIG. 4C, on top of stepper motor shaft 118 drives a gear train, which may include or consist of gears 361, 362, and 363. The gear ratios are chosen so that gear 363 makes one complete revolution for each complete revolution of the puck 1. The disk 331 (also shown in FIG. 4B) of the puck position sensing ring 330 is attached to gear 363 via a bushing 364 in such a way so as to insure the disk of the puck position sensing ring 331 can not rotate with respect to gear 363.

The puck position sensing ring 331 is encoded with lines that correspond to the angular or rotational position of the puck 1. Parts such as the puck 1, cylinder Head 100 and disk 331 should be manufactured with alignment marks so that during assembly, the puck 1 alignment mark is aligned with an alignment mark on cylinder Head 100, and, the puck position sensing ring 331 alignment mark is aligned with alignment mark on the ring 102 housing. These steps are important to ensure that the lines on the disk 331 correctly indicate the angular rotational position of the puck 1.

As an example, the following gearing can be used: Consider the puck 1 having three hundred gear teeth 29 (or 29a and 29b or similar) around the circumference 2a of the top, and Stepper motor pinion gear 120 having ten teeth. In this case, the stepper motor 104 will make thirty complete revolutions for one complete revolution of the puck 1. Referring to FIG. 4C, consider pinion gear 360 having ten teeth, gear 361 having thirty teeth, and its attached pinion gear 362 having six teeth, and gear 363 having sixty teeth. Gear 361 will make one complete revolution for three turns of the stepper motor shaft 118. Gear 363 will make ten complete turns of gear 361. Therefore gear 363 will make one complete turn for thirty complete rotations of stepper motor shaft 118, and therefore one complete revolution for one complete revolution of the puck 1. A mounting shaft 365 shown in FIG. 4C, serves to mount gear 363, bushing 364, disk 331 bushing 366, and sensor arm 338. Washers, bushings and spring clips (not shown) will be used as appropriate.

Sensing arm 332 can pivot a few degrees about mounting shaft 365 when solenoid 332 is energized under control of computer 340. This will enable a small portion of the markings 333a in ring 333 to be read by computer 340 when the engine is not running. When the engine is running, solenoid 332 will be in its de-energized state. and sensor arm will remain stationary. optical detectors 354 and 356 will read the encoded data on the puck position sensing ring disk 331 and provide this data to computer 340.

TABLE 2
Stepper Motor Sensing Ring Encoding:

| | | | | | | | | | |
|---|---|---|---|---|---|---|---|---|---|
| 10101 | 0000 | 10101 | 0001 | 10101 | 0010 | 10101 | 0011 | 10101 | 0100 |
| 10101 | 0101 | 10101 | 0110 | 10101 | 0111 | 10101 | 1000 | 10101 | 1001 |
| 10101 | 1010 | 10101 | 1011 | 10101 | 1100 | 10101 | 1101 | 10101 | 1110 |

As the puck 1 rotates from the exhaust port 132b to the intake port 124b, the pattern on the first line of Table 2 will be read. As the puck 1 rotates about pipe section 135 from the intake port 124 to the compression segment 131c in FIG. 2, the pattern on the second line of Table 2 will be read. As the puck 1 rotates from the compression segment to the exhaust port 132, the pattern on the third line will be read.

The computer 340 is programmed by a computer program to determine the orientation, angular or rotational position simply by reading one group of data bits of the stepper motor sensing ring 330, such as a set of four data bits as shown in Table 2. The computer 340, in at least one embodiment, is programmed by a computer program to rotate all the pucks to their correct position based on the positions and strokes of the pistons as determined as a result of decoding the distributor position sensing ring 301.

### Initiation of Puck Rotation:

Consider a traditional Chevrolet (trademarked) V8 automobile engine. Refer to Table 3 below. The left column is the firing order of the cylinders. The letters P, E, I and C represent the start of the Power stroke, Exhaust stroke, Intake stroke and the Compression stroke, respectively. The table represents eight intervals in one rotation of a distributor of the Chevrolet (trademarked) V8 automobile engine. (The last column is a repeat of the first column).

TABLE 3
Sequence of Puck Rotations in V8 Engine:

| | | | | | | | | | |
|---|---|---|---|---|---|---|---|---|---|
| First: | P | | E | | I | | C | | P |
| Eight: | | P | | E | | I | | C | |
| Four: | C | | P | | E | | I | | C |
| Third: | | C | | P | | E | | I | |
| Sixth: | I | | C | | P | | E | | I |
| Fifth: | | I | | C | | P | | E | |
| Sev. | E | | I | | C | | P | | E |
| Sec. | | E | | I | | C | | P | |

In at least one embodiment, for the above Table 3 example, rotation of the puck 1 is initiated at the start of the exhaust, intake and compression strokes. Typically, no puck rotation of puck 1, takes place at the start of the power stroke) It can be seen from Table 3 above that in each of the columns, three pucks (each similar or identical or puck 1) initiate rotation (C, I, or E in the column), and that these rotations start at approximately the same time.

In at least one embodiment, the encoding described in Table 1 and Table 2 is used during initialization. However, when the engine is running, it is not desirable to burden the computer 340 with processing the previously described encoded bit streams of tables 1 and 2. The distributor sensing ring 301 shown in FIG. 4, in at least one embodiment, contains another concentric ring 304 of encoded lines 304a-h. The detection of one of these eight lines 304a-h is used by the computer 340 to determine when to initiate the next rotation of the puck 1 The computer uses information contained in table 3 as a look up table to determine which pucks to rotate and which pucks remain at rest. In at least one embodiment, FIG. 4A shows eight lines 304a-h, illustrating operation for an eight cylinder engine. A six cylinder engine will have six lines in concentric ring 304, and a four cylinder engine will have four lines in concentric ring 304, etc. These eight lines 304a-h provide timing information to computer 340 from which, computer 340 can calculate when to start rotation of each of the pucks similar to puck 1.

Initiation of rotation of the puck 1 is often varied over the engine RPM range so as to tune the engine for optimum performance by the computer 340 in accordance with at least one embodiment of the present invention. The locations of the eight lines 304a-h, would represent the earliest point in time that any puck rotation of puck 1 would be initiated. For puck rotations or puck 1, that are not advanced as much, the computer 340 is programmed in at least one embodiment, to delay puck rotation of puck 1 with respect to the detection of lines 304a-h sensed on the distributor position sensing ring 304.

The computer 340 may control the V8 engine in the example above. The computer 340 in at least one embodiment receives eight pulses from the distributor sensing ring 301 for each rotation of the distributor of the V8 engine, and each pulse only initiates a rotation for three of the eight pucks (each similar or identical to puck 1). The computer 340 needs to keep track of piston positions and puck orientations or rotational or angular positions, so that the correct puck rotations are initiated at the correct times. The computer 340 may store in its computer memory a lookup table containing the information contained in table 3.

The computer 340 is programmed to read the distributor position sensing ring 313 with the encoded data bits often, and compare this with the data read from the puck position sensing ring 333 to ensure that the computer 340 not lost synchronization.

As described with the distributor sensing ring 301, the puck position sensing ring 331 could contain a second concentric ring of lines 332 shown in FIG. 4B. This second ring would contain three lines. The position of these lines would tell the computer 340 when the puck 1 was approaching one of the three rest orientations or angular positions. This information, in at least one embodiment is used by the computer 340 to know when to activate, energize and thereby apply the electromagnetic brakes 108, 111, 114 shown in FIG. 3B, causing the puck similar to puck 1 to stop in its correct rest position.

As an alternative embodiment of ring 332, instead of three lines, the exhaust rest orientation or rotational position of the puck 1 could be represented as one line, the intake rest orientation or rotational position of the puck 1 could be represented by a pair of lines, and the compression rest orientation or rotational position could be represented by three lines. These added lines tell the computer 340 through sensor 314 which segment the puck 1 is in, in addition to telling the computer 340 when the puck is approaching the rest orientation or rotational position.

Previously, it was described that the computer 340 can count stepper motor 104 rotations to know when to energize the electromagnetic brakes 108, 111, and 114. The feedback from the puck position sensing ring 302 could also serve this function. That is: when line 334a, 334b, or 334c is detected, computer 340 should energize the electromagnetic brakes for that puck.

### Computer Controlled Variable Valve Timing:

In traditional high performance engines such as those found in race cars, a trade off is often made in the cam design. In order to optimize high rpm (revolutions per minute) performance, the low rpm (revolutions per minute) performance is compromised.

Manufacturers of engines, such as automobile engines, have designed a mechanical “Variable Valve Timing” (V V T) which is known, for passenger vehicles, such as automobile vehicles, to allow an engine to idle smoothly at low RPMs, and still have high rpm performance. Mechanical variable valve timing is complex and therefore costly.

In at least one embodiment of the present invention, the puck 1 is a valve whose orientation or rotational or angular position and rotation are precisely controlled by the computer 340, via, in one embodiment, stepper motor 104 Therefore the valve timing can easily be changed. The rotation of the puck 1 can be advanced or retarded over the RPM range. Scavenging can be tuned over the rpm range.

This precise control of the puck orientation or rotational or angular position and rotation has other benefits such as low fuel consumption and low emissions. Passenger vehicles normally only operate at high RPMs for short durations—during acceleration. At other times, such as cruising at constant speed, and while at idle, the puck 1 rotational timing can be tuned for low fuel consumption and low emissions.

An important aspect of one or more embodiments of the present invention is Variable Valve Timing resulting from computer control by the computer 340 of orientation or rotational or angular position and rotation of the puck 1.

### Scavenging:

In existing internal combustion engines, such as automobile engines, at the end of the exhaust stroke, the intake valve is opened before the exhaust valve is closed. The momentum of the exhaust gases moving down the exhaust pipes causes fuel air mixture to be drawn into the combustion chamber, and the remaining exhaust gases are pulled out of the combustion chamber. Ideally, all the exhaust gases drawn out, but none of the fuel air mixture is drawn into the exhaust. Existing cam shafts attempt to achieve this balance, but can not vary scavenging (drawing out all exhaust gases) over the RPM range for the engine.

Referring to FIG. 2, as the puck 1 is rotated from head exhaust port 132b to head intake port 124b, a path is open from head intake port 124b to head exhaust port 132b, which supports scavenging. Timing of the puck 1 rotation allows tuning of the scavenging.

In one or more embodiments of the present invention, the puck 1 serves as both exhaust valve and intake valve. Referring to FIG. 5, when the puck 1 rotates from head exhaust port 132b to head intake port 124b, the puck port 24 will “straddle” the intake port 124b and exhaust port 132b of the cylinder head 100. The fuel air mixture will tend to be drawn along the top of FIG. 5 into the exhaust port 132b (polluting the air), while the exhaust gases will tend to remain in the lower portion (approximately ⅔) of the combustion chamber 32 of the puck 1 or the puck 401. The piston, whose dome 412 is shown in FIG. 5 is at top dead center at this moment, and a domed piston 412 will be used. The dome of piston 412 may be cupped out in location 410. While the puck 1 is rotating from exhaust port 132b to intake port 124b, in at least one embodiment of the present invention, the flow of fuel air mixture is directed in a clockwise direction around the piston dome 412. The curved radius 409 and the veins 402, 404 and 406, as well as cupping the piston dome 412 in location 410 all work together to send most of the fuel air mixture in a clockwise direction around the piston dome 410. In the design process, the engine manufacturer would “play” with the curved radius 409, spacing and number of veins (including veins 402, 404, and 406 and potentially further veins), and cupping of the piston dome 410, as well as the timing—(how early or late rotation is initiated) and the speed of rotation of the puck 1 in order to optimize scavenging. The computer control by the computer 340, enables the scavenging to be optimized over the RPM range. For example, the puck 1 could be rotated a few degrees (e.g. fifteen degrees) clockwise for a period of time long enough to achieve just the right amount of scavenging, then rotated counterclockwise approximately two thirds of a turn (e.g. two hundred and fifty five degrees) to the intake port 124b by computer control by the computer 340. FIG. 2 was drawn to illustrate an embodiment of the present invention. FIG. 5 provides added design details to optimize scavenging.

FIGS. 6A and 6B are a top and side views of an outline of the puck 401 in accordance with the embodiment of FIG. 5, and are shown as an aid to understanding the location of the scavenging veins 402, 404, and 406. Note that when the puck 401 first starts to rotate about pipe section 135 or pipe section analogous to 135, the veins 402, 404, and 406 are at an angle to the airflow resulting in maximum deflection. When the puck 401 completes its rotation and is aligned with the intake port 124b, the veins 402, 404, and 406 are in line with the air flow, providing minimal restriction.

The drawings illustrate operation where the puck 401 rotation is clockwise. In applications where the puck 401 rotates counterclockwise, that is, where the intake 424 is on the left and exhaust 432 is on the right, the scavenging veins 402, 404, and 406 would need to be on the other side of a puck port, that is, to the left side of the puck port as shown in FIG. 6B.

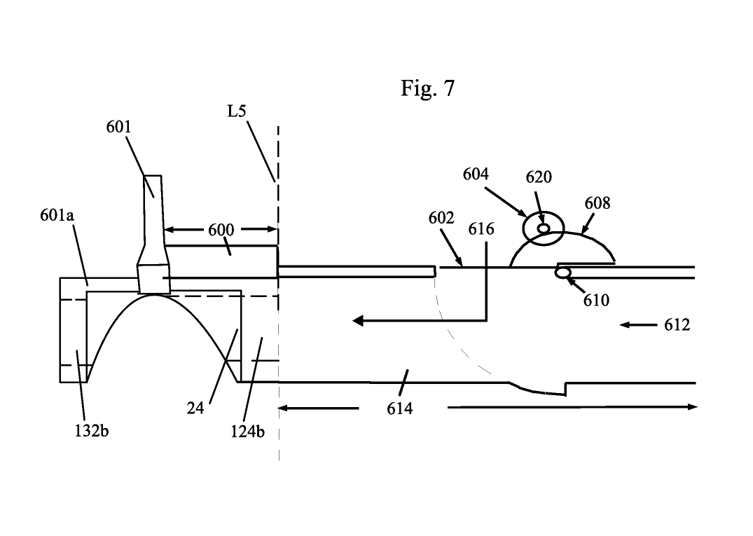

FIG. 7 shows an embodiment of this invention in which a swinging door 602 is installed in the intake manifold of a vehicle engine in order to provide an improved method of disengaging and re-engaging piston cylinders under control of computer 340. There is a vertical dotted line L5 in the FIG. 7. The cylinder head 100 is located to the left of the dotted line L5. To the right of the dotted line L5 is a portion of the intake manifold 614 of a vehicle engine.

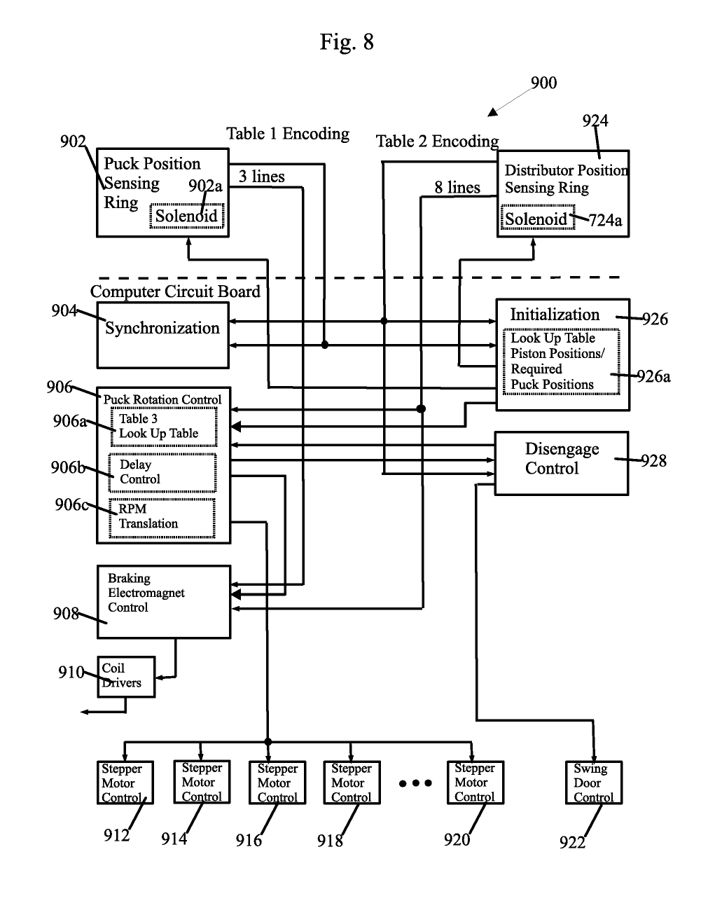

The swinging door 602 swings about a hinge 610. Attached to the swinging door 602 is a semicircular gear 608. A small stepper motor 604 is mounted on the intake manifold, Stepper motor 604 has a pinion gear 620 on its shaft which engages the semicircular gear 608. Swinging door 602 is shown in the “up” position in FIG. 8. The up position is the normal position when the associated piston cylinder is not disengaged.

At times when the engine not operating at full power, it is more fuel efficient for the engine to run on fewer piston cylinders. In accordance with one embodiment of the present invention, the computer 340 will be programmed to disengage some of the piston cylinders at times when fuel can be saved.

A piston cylinder will be disengaged, in at least one embodiment, in the following manner: at the end of the exhaust stroke, computer 340 will energize stepper motor 620 causing its pinion gear 620 to rotate semicircular gear 608, causing swinging door 602 to swing 90 degrees to the “down” position. In this position, the swinging door prevents fuel air mixture from being drawn into the piston cylinder via path 612.

At the end of the exhaust stroke, the computer 340 will also rotate the puck 1 so as to align the puck port 24 with the cylinder head 100 intake port 124b. The computer 340 will leave the puck 1 in this position until it is determined that the piston cylinder should be re-engaged. As the piston moves up and down, air from the atmosphere will move in and out via path 616 in FIG. 8. No fuel-air mixture will be drawn into the piston cylinder, conserving fuel.

At the end of the exhaust stroke, the computer 340 will also rotate the puck 1 so as to align the puck port 24 with the cylinder head 100 intake port 124b. The computer 340 will leave the puck 1 in this position until it is determined that the piston cylinder should be re-engaged. As the piston moves up and down, air from the atmosphere will move in and out via path 616 in FIG. 8. No fuel-air mixture will be drawn into the piston cylinder, conserving fuel.

When computer 340 determines that pistons should be re-engaged, It will cause stepper motor 620 to swing the swinging door 602 to the up position just as the piston completes an exhaust stroke. The puck port 24 will already be aligned with the head intake port 124b at this time. The computer 340 may be programmed by computer software to simply resume normal operation at this time, beginning with the intake stroke.

FIG. 8 is a block diagram 900 of a process and/or flow chart of a method which can be programmed in and executed by the computer 340 of FIG. 4. FIG. 8 is a high level block diagram to aid the understanding of how the Software controls the operation of this invention. The diagram 900 includes puck position sensing ring module 902, synchronization module 904, puck rotation control module 906, braking electromagnet control module 908, coil drivers 910, stepper motor control module 912, stepper motor control module 914, stepper motor control module 916, stepper motor control module 918, stepper motor control module 920, swing door control module 922, distributor position sensing ring module 924, initialization module 926, and disengage control module 928. Each of the modules 902, 904, 906, 908, 912, 914, 916, 918, 920, 922, 924, 926, and 928 may be a computer software program or programs which is executed by computer 340 of FIG. 4.

Tasks of the control software implemented by computer 340 may include: Initialization of puck orientations or rotational or angular positions at engine start up; rotating the puck 1 such as by controlling stepper motor 104; energizing the braking electromagnets 108, 114 and 111; verifying that puck positions are correctly synchronized to the piston positions; varying puck 1 rotation timing over the RPM range to optimize performance, fuel efficiency, and scavenging, Continuously Variable Valve Timing and to minimize emissions; and to disengaging and re-engage piston cylinders of engine to optimize fuel efficiency;

### Initialization:

Consider conditions such as: starting an engine, such as an automobile engine having cylinder head 100 and to be used with puck 1, removing a battery of an automobile or otherwise removing power from a computer 340. Consider also, that when the engine having cylinder head 100 of FIG. 3, is turned off, the orientations or rotational or angular positions of the plurality of pucks, such as puck 1, or puck 401, may not correspond correctly to the piston positions of the engine, the next time the engine is started.

### Initialization:

The initialization block 926 is shown in FIG. 8. The computer 340 will initialize each puck of a plurality of pucks (each puck similar or identical to puck 1 of FIG. 1A) to its correct orientation or rotational or angular position each time the engine is started. To do this, the computer 340 obtains data from the distributor position ring shown in FIG. 4A. Computer 340 uses this data in conjunction with a lookup table to determine the positions of all the pistons of the engine and which stroke each piston is in. The distributor position sensing ring can be read in either of two ways: Before the engine starts to turn over, computer 340 can energize solenoid 322, and as sensor arm 318 pivots about the distributor shaft 310, optical sensor 316 shown FIG. 4A can read the sensing ring pattern 313a. Alternatively, as the engine turns over, the distributor sensing ring will be rotating and sensor 316 of FIG. 4A can read the sensing ring pattern 313a.

The solenoid 322 in FIG. 4A will be energized, and then de-energized when the distributor sensing ring 301 is read (without the distributor shaft turning). Thus the sensor 316 will be able to read the ring 313 bit stream forward, then backward. The direction in which the data pattern of table 1 is laid out on the distributor position sensing ring 301 will of course depend on the normal direction of rotation of the distributor shaft 310 when the engine is running. The data of table 1 will therefore be laid out such that it will be read forward (left to right in table 1) while the engine is running. The computer 340 will be programmed to process the data that is read either when the solenoid is energized or de-energized, depending on the normal direction of the distributor shaft rotation. For example: If the distributor shaft 310 rotates in a clockwise direction, then the data in table 1 will be encoded on 313 in the counterclockwise direction, and computer 340 will process the data it reads while the solenoid 322 is energized. Similarly, if the distributor shaft turns counterclockwise while the engine is running, then computer 340 will process the data it reads while the solenoid 322 is de-energized).

While the piston positions are being determined computer 340, computer 340 may determine the puck angular positions for the plurality of pucks similar to puck 1 or 401 in the engine. This can be accomplished in two ways: Computer 340 can energize solenoid 332 shown in FIG. 4B and as sensor arm 338 pivots about the POST 365, optical sensor 356 shown FIG. 4B can read the sensing ring pattern 333. Alternatively, computer can rotate each puck and read the puck position sensing ring.

Computer 340 will use the known puck positions in conjunction with a lookup table containing the information presented in table 3 to determine the correct position for each puck in the engine. Computer 340 will then rotate each puck to this correct angular position.

Consider: When the engine was last turned off, some pistons may be in the compression or power stroke. Therefore there may be pressure in the piston cylinders. It would not be desirable for this pressure to release into the intake manifold. This will normally not be a problem, however, because normal puck rotation is from intake segment to compression segment to exhaust segment. As long as the computer rotates the pucks in this normal direction when reading the puck position sensing ring the puck will never rotate from the compression segment to the intake segment.

The solenoid 322, and the sensor arm 318 in FIG. 4A are used to read the distributor position ring 300 when the engine is not turning. Similarly, The solenoid 332, and the sensor arm 338 in FIG. 4B are used to read the puck position ring 330 without rotating the puck. In one embodiment of this invention, the solenoids 322 and 332 may not be needed, and the sensing arms may be replaced with a nonmoving part to hold the optical sensors 314, 316 and nonmoving part to hold the optical sensors 354, 356. Computers are fast, and while the engine is turning over (being started), computer can rotate the pucks to determine their positions from the puck position ring while the piston positions are being determined from the distributor position sensing ring 300. The computer would quickly rotate the pucks to their correct positions on the fly, as the engine turns over.

In an alternative embodiment of this invention, as the engine is turned off, the computer 340 can read the distributor position sensing ring 300, thus knowing the final position and stroke of each piston. The computer can store this information in nonvolatile memory, and assure that all pucks are rotated to the correct angular position corresponding to the final positions of the pistons. The next time the engine is started, the initialization routine may still be performed, to assure the puck angular positions correspond correctly to the positions of the pistons. This may enable the engine to start faster and smoother.

The bit patterns in table 1 consist of a sync pattern 10101, with five data bits between each sync pattern. This encoding of the distributor sensing ring 301 permits the positions of all the pistons of the engine to be determined by rotating the distributor sensing ring 301 only a small fraction of a turn, enough to read one of the 5 bit data patterns. The computer 340 can determine the piston positions when the engine is not running, by energizing solenoid 322. This will cause the sensing arm 318 to rotate about distributor shaft 310 allowing optical sensor 316 to read the pattern 313 that is described in table 1, The solenoid should move sensor arm 318 through 17 degrees in order to assure one set of five data bits is read. (There are sixty four groups of five bits in one revolution of disk 301, so each five bits takes up 5.625 degrees. Reading 15 bits assures reading five bits of data).

### Synchronization:

The outer ring 313 of the distributor position sensing ring 301 contains the data of table 1, and provides detailed data as to the position of the distributor shaft. The inner ring 304 of the distributor position sensing ring 301 contains one line for each piston cylinder in the engine (eight lines for a v8). Similarly, the outer ring 333, shown in FIG. 4B of the Puck Position Sensing Ring contains the data of table 2, and provides detailed data as to the angular or rotational position of the puck 1. The inner ring 332 of the Puck Position Sensing Ring 330 contains three lines which the computer 340 uses to know when the puck 1 is approaching one of the three rest positions. The Data from the outer rings 313 and 333 of the Distributor Position Sensing Ring 301, shown in FIG. 4A, and the Puck Position Sensing Ring 331, shown in FIG. 4B, respectively, is primarily used by computer 340 during initialization, While the data from the inner rings 302 and 332 of the Distributor Position Sensing Ring 301 in FIG. 4A, and the Puck Position Sensing Ring in FIG. 4B, respectively, is primarily used by computer 340 while the engine is running. This is done so that computer 340 does not need to crunch the excess data provided by these outer rings 313 (FIG. 4A) and 333 (FIG. 4B), as the inner rings 304 (FIG. 4A) and 332 (FIG. 4B) provide sufficient data.

However, While the engine is running, the computer 340 should check and verify synchronization often to verify that the angular positions of all pucks correctly correspond to the position and stroke of their associated pistons. Computer 340 does this by reading the outer ring 313 of the distributor position sensing ring 301 (FIG. 4A) (for the particular piston cylinder head, such as 200, or analogous piston for plurality of pistons, and the outer ring 333 of the puck position sensing ring 331 via sensors 316 and 356, respectively, to verify that the puck orientation or rotational or angular position is correct with respect to the position and stroke of the associated piston. The synchronization will also check to assure that the pointer for the Table 3 lookup table 906a points to the correct column of table 3 corresponding to the piston positions as described in the next paragraph. This is done much the same way as done during initialization. The computer 340 is programmed by computer software to check synchronization frequently, for example, each time puck 1 rotation is initiated.

### Normal Operation: Engine Running:

The puck rotation control block 906 is shown in FIG. 11. This software module controls all puck rotation, most importantly puck rotation while the engine is running. The computer software will have a lookup table of data stored in computer memory of computer 340 containing the information previously presented in Table 3. This is shown as 906a in FIG. 8. A pointer will point to a column in Table 3. The pointer will be advanced one column each time one of the eight lines 304a-g on the distributor position sensing ring 304 is detected. The Table 3 identifies which pucks are to initiate rotation in response to detecting one of the eight lines 304a-g. The software is then executed by the computer 340 to initiate puck rotation of the pucks that should be rotated according to table 3 via stepper motor 104 through stepper motor control 912, and similarly for other pucks through stepper motor controls 914, 916, 918, and 920 through stepper motors by outputting a stream of pulses to the appropriate stepper motor controls, which control an appropriate stepper motor.

As previously described, the positions of the eight lines 304a-g are advanced in time to indicate the earliest time of rotation of puck 1 over the RPM range. The computer 340 is programmed by computer software to determine the RPMs of the engine by measuring the time between each of the eight lines 304a-g, or by any other suitable means. This is done in 906c in FIG. 8. For puck rotations that are less advanced, the computer 340 delays puck rotation from the line detection. This delay may vary for exhaust to intake, intake to compression, and compression to exhaust puck rotations. The computer 340 will contain a “delay” look up table, shown as 906b in FIG. 8, in its computer memory for this purpose. A pointer points to the correct delay, based on RPMs and which segment of the cylindrical head cavity, such as cavity 130 of the cylinder head 100, the puck 1 is in.

Speed of puck rotation may also vary with RPMs, especially to optimize scavenging. Module 906c will also contain a look up table that contains stepper motor speed of rotation based on RPMs.

It was also described earlier, that scavenging might be optimized, especially at low RPMs, by rotating the puck 1 a few degrees clockwise, then rotating the puck 1 counterclockwise ⅔rd of a revolution. Module 906c will also control this operation, based on RPMs.

Energizing and de-energizing the braking electromagnets 108, 114 and 111 shown in FIG. 3 and FIG. 3a is controlled by software module 908 shown in FIG. 11. The stepper motor 104 rotates the puck from its last rest position as controlled by software module 906. Module 908 monitors the “three lines” output from module 902 to determine when to energize the electromagnets 108, 114 and 111. Alternatively, module 906 can count stepper motor rotations and tell module 908 when to energize electromagnets 108, 114 and 111.

Energizing the braking electromagnets 108, 114 and 111 causes an attraction with puck magnets 4 6 and 8 pulling the puck into alignment with the new rest position.

Module 906 determines when to initiate puck rotation. Module 906 also provides this information to module 908. Module 908 de-energizes the electromagnets 108, 114 and 111 in response to this information.

When the engine is running at high RPMs, This rotation needs to be very fast. Fastest rotation may be achieved by accelerating the puck rotation using the stepper motor 104, then bringing the puck quickly to a stop using the braking electromagnets 108, 114 and 111.

The Disengage software control module is shown as 928 in FIG. 8. The process has been described in detail in the detailed description of FIG. 8.

### Sealing the Puck 1 or 401:

The puck 1 (or 401), in at least one embodiment should have a diameter D1, shown in FIG. 1A, such that D1 is slightly smaller, than a diameter D2 of the cylindrical head cavity 130 shown in FIG. 3, to allow for rotation of the puck 1 about pipe section 135, and to allow for expansion and contraction of the puck 1 and cylindrical head cavity 130 over temperature. The puck 1, in at least one embodiment, must be sealed to prevent any leaking, especially during the compression and power strokes of an engine used with the puck 1. There are numerous ways in which this sealing can be implemented.

### Close Tolerance:

It may be possible to have a close fit between the puck 1 or 401 and the cylindrical head cavity 130, similar to the fit of a crank shaft in its journal. Engine oil can be used to enter the space between the puck 1 and the cylindrical head cavity 130 through small holes in the cylindrical head cavity 130 to keep this space well lubricated. As the parts of the engine increase in temperature, they will normally expand. The cylindrical head cavity 130 will expand as will the puck.1 Since the puck 1 and the space it fits in, cylindrical head cavity 130 both get larger, the close tolerance fit may successfully seal the puck 1 or 401.

As described in the next section, piston type rings 28 and 27, as shown in FIG. 1R and FIG. 1S are installed, in at least one embodiment, around the top and bottom of the puck 1 to prevent oil from leaking down into the piston cylinder, as well as sealing the puck 1 or 401 to the cylindrical head cavity 130.

If thermal expansion of the puck 1 is a concern, a ceramic material with low coefficient of thermal expansion may be used for both the puck 1 and cylindrical head cavity 130 in order to allow effective puck 1 sealing over the temperature range.

### Piston Ring Type Sealing:

Grooves could be machined around the circumference 2a of the puck 1, shown in FIG. 1A, near the top and bottom of the puck 1 that would accept rings 27 and 28 shown in FIG. 1R and FIG. 1S. These rings 27 and 28 would be similar to piston rings. Additionally, vertical grooves could be machined to accept straight pieces of this ring type material shown as members 31 and 33 in FIG. 1R. Zigzag shaped pieces of springy metal could be installed in the vertical grooves in peripheral surface 3, that would push the straight pieces of ring material 31 and 33snug against the cylindrical head cavity wall 130. The vertical sealing pieces or members 31 and 33 would be located on either side of the puck port 24. Where the rings 27 and 28 and members 31 and 33 contact the cylindrical head cavity wall 130d shown in FIG. 3, lubricating holes (not shown) would allow a small amount of oil to lubricate this contact surface.

There is a concern that carbon could build up in the space between the puck 1 and cylindrical head cavity 130. The vertical sealing pieces or members 31 and 33 shown in FIG. 1R would serve to prevent (scrape away) this carbon buildup.

### Puck 1 Inertia and Balance:

The puck 1 needs to be balanced in order to eliminate vibrations and prevent premature wear. The puck 1 mass is symmetrical except for the puck port 24 opening through to the combustion chamber 32 shown in FIG. 1R. Material should be machined out of the puck 1 (such as by drilling down through the top of the puck 1) opposite the puck port 24 to balance the puck 1—similar to balancing a tire. (Normally, this would be done during design/development. The precision of today's CNC (computer numerical control) machining will allow repeatability from part to part without requiring each part to be balanced).

The mass of the puck 1 near its circumference 2a contributes to the angular momentum and inertia of the puck 1. In order to achieve quick rotational acceleration and deceleration of the puck 1, its angular momentum and inertia needs to be minimized, while still maintaining strength of the puck 1. Material may be machined out of the top of the puck 1 to reduce mass near the circumference 2a.

In at least one embodiment of the present invention, the body of puck 1 is constructed of an aluminum alloy or other nonferrous material, as opposed to iron. The lighter weight of aluminum alloy as opposed to iron minimizes momentum and inertia. More importantly, a nonferrous material is needed, in at least one embodiment, so as not to interfere with braking permanent magnets 4, 6, and 8 of FIG. 1A and the braking electromagnets 108, 114, 111 of FIGS. 3 and 3A.

The outer shape of the puck 1 can be changed from cylindrical to a tapered or hemispherical shape to reduce mass near the circumference 2a. A hemispherical shape would provide somewhat uniform wall thickness, and would tend to minimize inertia. The cylindrical head cavity 130 in the cylindrical head 100 shown in FIG. 3A would machined to match the outer shape of the circumference 2a of the puck 1.

As an alternative embodiment of this invention, consider the puck 1 with a hemispherical outer shape for circumference 2a of the puck 1. The cylindrical head cavity 130 would be made hemispherical to match the outer shape of the puck. Such a design has the advantages of uniform puck wall thickness in addition to minimizing momentum and inertia.

FIG. 3A, as well as other figures show the spark plug installed in location 134. This location may be considered ideal for uniform burn of the fuel air mixture. FIG. 3A, as well as other figures show the stepper motor 104 driving gear teeth 29 that go around the circumference of the puck. This configuration transfers maximum torque to the puck and may allow a smaller, less expensive motor to be used. In an alternative embodiment of this invention, a stepper motor may be installed in the former location of the spark plug. The stepper motor shaft would pass through location 134 shown in FIG. 3A, and drive the puck 1 or 401 directly. In this configuration, a threaded hole could be made in the cylinder head 100 adjacent the compression segment 131c shown in FIG. 2. This would permit the spark plug to fire through the puck port 24 initiating the power stroke.

### Fuel Efficiency:

A conventional known engine, such as an automobile engine, has to work to push air through the constricted openings of conventional valves. This in itself robs power from the engine. The high flow capability of an apparatus including a puck, such as puck 1 of embodiments of the present invention, means that the engine does not need to work as hard to move the air, and does not have to compress the valve springs, of conventional engines etc. of a known automobile engine used in conjunction with a puck 1 of embodiments of the present invention.

Generally speaking, an engine is essentially an air pump. An engine that breaths well performs well. Conventional valves are like breathing through a straw. You won't win a marathon or one hundred yard dash trying to breathe through a straw.

### Compression Ratio:

The use of a domed piston, such as 204 of FIG. 3A, and a hemispherical puck combustion chamber 32 of FIG. 3A for puck 1 or puck 401, permits high compression ratios to be achieved. At high RPMs, a traditional engine opens the intake valve before the exhaust valve is closed. This is done while the piston is at top dead center. There needs to be enough space in the traditional combustion chamber so that these valves can be open without making contact with the piston. In one or more embodiments, the present invention is not limited by this constraint, and can achieve as high a compression ratio as the engine can handle.

### Noninterference Engine:

One or more embodiments of this invention provide the benefit of a noninterference engine. In traditional car engines, there is a timing belt or timing chain that mechanically couples the crankshaft to the camshaft. In many of these engines, if the timing belt or chain breaks (or slips), The pistons may hit open valves virtually destroying the engine. As a traditional engine gets up in miles, standard maintenance schedules call for replacement of timing chain or belt—an expensive preventive maintenance step. This invention does not have any valves that can come in contact with pistons. It is therefore more reliable, and less costly to maintain

The drawing Figs. are not exact. The puck 1 and the cylindrical head cavity 130 are round, in at least one embodiment, and not elliptical, as may appear in the drawings.

The drawings are provided to make this invention easier to understand. The drawings are not drawn to scale. Not all drawings contain all details. For example some drawings of the puck 1 do not show the braking permanent magnets. Similarly, fasteners (bolts, etc) are not shown on the drawings.

In some drawings, details are implied. For example, in FIG. 4, some lines 313 are drawn near the circumference within the distributor sensing ring 301. These lines show the “encoding shown in Table 2”. These lines would typically, in at least one embodiment, go all the way around the circumference of the sensing ring 301

### Construction of One or More Embodiments of the Present Invention

One or more embodiments of the present invention provide a puck 1 which can be used in a cylinder head 100 which can be used in an internal combustion engine. The body of puck 1, as well as the cylinder head 100 would typically be constructed using aluminum or an aluminum alloy, using many of the same manufacturing techniques as conventional cylinder heads (sand mold casting which is machined, usually using CNC tooling). The cylinder head 100 would have passages for cooling and lubrication, similar to traditional heads.

The intake and exhaust manifolds would need to be changed to have larger port sizes to take full advantage of the high flow capability of one or more embodiments of the present application. The intake manifold of known engines would need to be changed to accommodate the “swinging door” 602 of FIG. 7, if the benefit of this method of disengaging cylinders were to be implemented.

Applications of one or more embodiments of the present invention include all or nearly all vehicle engines. Some of these may be race car engines, high performance passenger automobile vehicles, or fuel efficient economy vehicles. As with all traditional known engines, a lot of tuning may be needed to optimize it for its intended application.

Tuning may include mechanical tuning as well as computer software tuning. Mechanical tuning involves such issues as: Height, and diameter of the puck 1, and size of the combustion chamber 32 shown in FIG. 3, number and spacing of the scavenging veins 402, 404, and 406, if used for a modified puck 401, shown in FIG. 5.

### Disengaging Piston Cylinders:

### Decision When to Engage and Disengage Piston Cylinders:

Disengaging and re-engaging pistons is known in the automotive industry. One or more embodiments of the present invention using the rotating puck 1 (or 401 or other alternative pucks) allows pistons to be engaged and disengaged with minimal mechanical complexity, and is therefore an improved method of engaging and disengaging cylinders.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a solid portion having a first opening, a second opening, a third opening, and a chamber;
wherein the first opening, the second opening, and the third opening lead to the chamber;
wherein the first opening is located a top of the solid portion;
wherein the second opening is located at a bottom of the solid portion, opposite the top of the solid portion;
wherein the third opening is located at a periphery of the solid portion, wherein the periphery is substantially perpendicular to the top and the bottom of the solid portion;
and the apparatus further comprising
a plurality of gear teeth located nearer the top of the solid portion than the bottom of the solid portion;
a first magnet located nearer the top of the solid portion than the bottom of the solid portion; and
a first plurality of ball bearings located nearer the top of the solid portion than the bottom of the solid portion.

2. The apparatus of claim 1 wherein
the solid portion has a substantially cylindrical outer shape.

3. The apparatus of claim 1 further comprising
an internal combustion engine cylinder head having a cylindrical cavity;
wherein the solid portion is mounted in the cylindrical cavity of the internal combustion engine so that the solid portion can rotate within the cylindrical cavity.

4. The apparatus of claim 3 wherein
the internal combustion engine cylinder head includes a first electromagnet;
and wherein the solid portion rotates at least in part in response to the first electromagnet interacting with the first magnet.

5. The apparatus of claim 4 further comprising
a computer; and
wherein the computer is programmed to control the first electromagnet and thereby control, at least in part, the rotation of the solid portion.

6. The apparatus of claim 3 wherein
the internal combustion engine cylinder head has an exhaust port and an intake port;
and wherein the solid portion is configured to be rotated to align the third opening with the exhaust port but not the intake port, in a first orientation state; and
and wherein the solid portion is configured to be rotated to align the third opening with the intake port but not the exhaust port, in a second orientation state.

7. A method comprising
inserting a solid portion into a cylindrical head cavity of an internal combustion cylinder head so that the solid portion can rotate;
wherein the solid portion has a first opening, a second opening, a third opening, and a chamber;
wherein the first opening, the second opening, and the third opening lead to the chamber;
wherein the first opening is located a top of the solid portion;
wherein the second opening is located at a bottom of the solid portion, opposite the top of the solid portion;
wherein the third opening is located at a periphery of the solid portion, wherein the periphery is substantially perpendicular to the top and the bottom of the solid portion;
and wherein a plurality of gear teeth are located nearer the top of the solid portion than the bottom of the solid portion;
wherein a first magnet is located nearer the top of the solid portion than the bottom of the solid portion; and
and wherein a first plurality of ball bearings are located nearer the top of the solid portion than the bottom of the solid portion.

8. The method of claim 7 wherein
the solid portion has a substantially cylindrical outer shape.

9. The method of claim 7 wherein
the internal combustion engine cylinder head includes a first electromagnet;
and wherein the solid portion rotates at least in part in response to the first electromagnet interacting with the first magnet.

10. The method of claim 9 further comprising
using a computer to control the first electromagnet and thereby control, at least in part, the rotation of the solid portion.

11. The method of claim 10 wherein
the internal combustion engine cylinder head has an exhaust port and an intake port;
and further comprising rotating the solid portion to align the third opening with the exhaust port but not the intake port, in a first orientation state; and
and rotating the solid portion to align the third opening with the intake port but not the exhaust port, in a second orientation state.
